(19) United States
(12) Patent Application Publication
(10) Pub. No.: US 2004/0207881 A1
(43) Pub. Date: Oct. 21, 2004

(54) Image processing method, image processing apparatus and image processing program

(75) Inventor: Shoichi Nomura, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc., Tokyo (JP)

(21) Appl. No.: 10/819,780

(22) Filed: Apr. 6, 2004

(30) Foreign Application Priority Data
Apr. 15, 2003 (JP) JP2003-110609

(51) Int. Cl. H04N 1/409; G06T 5/00

(52) U.S. Cl. 358/3.24; 382/261; 382/266; 382/199; 382/195; 358/3.27

(57) ABSTRACT

There is described a method for processing an input image, so as to output a processed image. The method includes the steps of: deriving image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and applying a sharpness-enhancement processing to the image-processing object pixel, based on the image characteristic information. The image characteristic information includes at least one of a sum of differential signal absolute-values between the adjacent pixels residing in the predetermined area, a variance of each signal value of the adjacent pixels residing in the predetermined area and a standard deviation of each signal value of the adjacent pixels residing in the predetermined area.

### BACKGROUND OF THE INVENTION

The present invention relates to an image processing method, an image processing apparatus and an image processing program.

In recent years, there has been widespread use of the technology of applying adequate image processing to the image information acquired by scanning a developed photographic film with a film scanner and to the image information acquired by photographing with a digital still camera; wherein the resulting image is then outputted to a printer or a recording medium such as a CD-R. There are a wide variety of image processing methods. One of the particularly frequently used methods is sharpness-enhancement processing for enhancing the sharpness of an image. Sharpness-enhancement processing is mainly designed to enhance the minute structure of the image, and is capable of making up for insufficient sharpness of the image.

Generally, an image is mixed more or less with noise components. The major causes include granularity of a silver halide film, various types of electric noise of the CCD sensor and various noises added in the signal processing system. It is practically impossible to completely eradicate such noise. The aforementioned sharpness-enhancement processing tends to enhance such noise. A sharp image is often characterized by conspicuous granularity or electric noise.

To solve this problem, various image processing methods have been proposed to provide an art capable of enhancing the sharpness while reducing the noise components contained in the image, and have been put into practical use. An example of such image processing methods is disclosed in Patent Document 1 wherein one technique is to set an upper boundary to the effect of sharpness enhancement so that a strong noise is not excessively increased, and another technique is to operate two types of noise filters prior to sharpness enhancement, whereby noise is removed prior to sharpness enhancement.

[Patent Document 1]

Tokkai 2002-262094

However, minute image signals may be contained in the noise components removed by noise processing even though in a very small amount. Thus, this prior art has a problem in that the details of image are gradually lost as the effect of the noise filter is increased. Especially the noise of an isolated point such as pulse noise appears as a very strong signal value in some cases, and is very conspicuous in the image. To remove such a powerful noise, the noise filter is required to have a powerful noise eliminating effect. The details of the image are lost to a larger degree. Further, as described in the Patent Document 1, the method of setting an upper boundary to the effect of sharpness enhancement has a problem in that the sharpness enhancement effect is reduced. Thus, although granularity can be reduced to improve sharpness to some extent, the prior art image processing method has failed to provide sufficient control of mutually conflicting functions of reducing the granularity and improving the sharpness.

### SUMMARY OF THE INVENTION

To overcome the abovementioned drawbacks in conventional image-processing methods and apparatus, it is an object of the present invention to provide image-processing method and apparatus, which make it possible to improve the sharpness of the image while suppressing noises included in the image.

Accordingly, to overcome the cited shortcomings, the abovementioned object of the present invention can be attained by image-processing methods and apparatus, and computer programs described as follow.

(1) A method for processing an input image, so as to output a processed image revised from the input image, comprising the steps of: deriving image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and applying a sharpness-enhancement processing to the image-processing object pixel, based on the image characteristic information derived in the deriving step.

(2) The method of item 1, wherein the image characteristic information includes at least one of a sum of differential signal absolute-values between the adjacent pixels residing in the predetermined area, a variance of each signal value of the adjacent pixels residing in the predetermined area and a standard deviation of each signal value of the adjacent pixels residing in the predetermined area.

(3) The method of item 1, further comprising the step of: selecting a specific spatial filter out of a plurality of spatial filters, which are different relative to each other in terms of relationships between image-edge directions and edge-enhancing degrees, based on the image characteristic information derived in the deriving step; wherein the specific spatial filter, selected in the selecting step, is employed for the sharpness-enhancement processing.

(4) A method for processing an input image, so as to output a processed image revised from the input image, comprising the steps of: deriving image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and selecting a specific spatial filter out of a plurality of spatial filters, which are different relative to each other in terms of relationships between image-edge directions and edge-enhancing degrees, based on the image characteristic information derived in the deriving step; applying a sharpness-enhancement processing to the image-processing object pixel, by employing the specific spatial filter selected in the selecting step.

(5) The method of item 4, wherein, in the deriving step, a multi-resolution conversion processing is applied to the input image so as to decompose the input image into a plurality of decomposed images, and then, the image characteristic information are derived from the plurality of decomposed images generated by the multi-resolution conversion processing.

(6) The method of item 5, wherein, in the deriving step, a Dyadic Wavelet transform is employed in an image-decomposing process at a level higher than at least level 2 of the multi-resolution conversion processing, and then, edge information, serving as the image characteristic information with respect to edge portions included in the input image, are derived from the plurality of decomposed images generated by the Dyadic Wavelet transform.

(7) The method of item 4, wherein, in the deriving step, information, representing a dispersion degree of signal values of plural pixels residing on positions being substantially equidistant from the image-processing object pixel in the predetermined area, are derived as the image characteristic information.

(8) An apparatus for processing an input image, so as to output a processed image revised from the input image, comprising: a deriving section to derive image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and an image-processing section to apply a sharpness-enhancement processing to the image-processing object pixel, based on the image characteristic information derived by the deriving section.

(9) The apparatus of item 8, wherein the image characteristic information includes at least one of a sum of differential signal absolute-values between the adjacent pixels residing in the predetermined area, a variance of each signal value of the adjacent pixels residing in the predetermined area and a standard deviation of each signal value of the adjacent pixels residing in the predetermined area.

(10) The apparatus of item 8, further comprising: a filter selecting section to select a specific spatial filter out of a plurality of spatial filters, which are different relative to each other in terms of relationships between image-edge directions and edge-enhancing degrees, based on the image characteristic information derived by the deriving section; wherein the image-processing section employs the specific spatial filter, selected by the filter selecting section, for conducting the sharpness-enhancement processing.

(11) An apparatus for processing an input image, so as to output a processed image revised from the input image, comprising: a deriving section to derive image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and a filter selecting section to select a specific spatial filter out of a plurality of spatial filters, which are different relative to each other in terms of relationships between image-edge directions and edge-enhancing degrees, based on the image characteristic information derived by the deriving section; an image-processing section to apply a sharpness-enhancement processing to the image-processing object pixel, by employing the specific spatial filter selected by the filter selecting section.

(12) The apparatus of item 11, wherein the deriving section applies a multi-resolution conversion processing to the input image so as to decompose the input image into a plurality of decomposed images, and then, derives the image characteristic information from the plurality of decomposed images generated by applying the multi-resolution conversion processing.

(13) The apparatus of item 12, wherein the deriving section employs a Dyadic Wavelet transform in an image-decomposing process at a level higher than at least level 2 of the multi-resolution conversion processing, and then, derives edge information, serving as the image characteristic information with respect to edge portions included in the input image, from the plurality of decomposed images generated by applying the Dyadic Wavelet transform.

(14) The apparatus of item 11, wherein the deriving section derives information, representing a dispersion degree of signal values of plural pixels residing on positions being substantially equidistant from the image-processing object pixel in the predetermined area, as the image characteristic information.

(15) A computer program for executing operations for processing an input image, so as to output a processed image revised from the input image, comprising the functional steps of: deriving image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and applying a sharpness-enhancement processing to the image-processing object pixel, based on the image characteristic information derived in the deriving step.

(16) The computer program of item 15, wherein the image characteristic information includes at least one of a sum of differential signal absolute-values between the adjacent pixels residing in the predetermined area, a variance of each signal value of the adjacent pixels residing in the predetermined area and a standard deviation of each signal value of the adjacent pixels residing in the predetermined area.

(17) The computer program of item 1, further comprising the functional step of: selecting a specific spatial filter out of a plurality of spatial filters, which are different relative to each other in terms of relationships between image-edge directions and edge-enhancing degrees, based on the image characteristic information derived in the deriving step; wherein the specific spatial filter, selected in the selecting step, is employed for the sharpness-enhancement processing.

(18) A computer program for executing operations for processing an input image, so as to output a processed image revised from the input image, comprising the functional steps of: deriving image characteristic information of a predetermined area, which includes adjacent pixels and is located in a vicinity of an image-processing object pixel other than the adjacent pixels, from information of the adjacent pixels residing in the predetermined area, both the adjacent pixels and the image-processing object pixel being included in the input image; and selecting a specific spatial filter out of a plurality of spatial filters, which are different relative to each other in terms of relationships between image-edge directions and edge-enhancing degrees, based on the image characteristic information derived in the deriving step; applying a sharpness-enhancement processing to the image-processing object pixel, by employing the specific spatial filter selected in the selecting step.

(19) The computer program of item 18, wherein, in the deriving step, a multi-resolution conversion processing is applied to the input image so as to decompose the input image into a plurality of decomposed images, and then, the image characteristic information are derived from the plurality of decomposed images generated by the multi-resolution conversion processing.

(20) The computer program of item 19, wherein, in the deriving step, a Dyadic Wavelet transform is employed in an image-decomposing process at a level higher than at least level 2 of the multi-resolution conversion processing, and then, edge information, serving as the image characteristic information with respect to edge portions included in the input image, are derived from the plurality of decomposed images generated by the Dyadic Wavelet transform.

(21) The computer program of item 18, wherein, in the deriving step, information, representing a dispersion degree of signal values of plural pixels residing on positions being substantially equidistant from the image-processing object pixel in the predetermined area, are derived as the image characteristic information.

Further, to overcome the abovementioned problems, other image-processing methods and apparatus, and computer programs, embodied in the present invention, will be described as follow:

(22) An image-processing method, characterized in that,

in the image-processing method for applying a sharpness-enhancement processing to an input image and outputting, the method includes:

a deriving process for deriving image characteristic information of a predetermined area from information of pixels residing in a vicinity of an image-processing object pixel and residing in the predetermined area, which do not include the image-processing object pixel; and

an image-processing process for applying the sharpness-enhancement processing to the image-processing object pixel, based on the image characteristic information derived.

(23) An image-processing apparatus, characterized in that,

in the image-processing apparatus, which applies a sharpness-enhancement processing to an input image and outputs, the image-processing apparatus is provided with:

a deriving section to derive image characteristic information of a predetermined area from information of pixels residing in a vicinity of an image-processing object pixel and residing in the predetermined area, which do not include the image-processing object pixel; and

an image-processing section to apply the sharpness-enhancement processing to the image-processing object pixel, based on the image characteristic information derived.

(24) An image-processing program for making a computer, for conducting image processing, to realize:

a deriving function for deriving image characteristic information of a predetermined area from information of pixels residing in a vicinity of an image-processing object pixel and residing in the predetermined area, which do not include the image-processing object pixel; and

an image-processing function for applying the sharpness-enhancement processing to the image-processing object pixel, based on the image characteristic information derived.

According to invention described in the items 1, 8, 15 and 22-24, it is possible to suppress enhancement of image noise tending to be conspicuous in the processing of image noise such as noise of an isolated point, by applying a sharpness-enhancement processing based on the conditions of pixels in the peripheral area without containing a processing object pixel, whereby an image with minimized noise can be provided.

(25) The image-processing method, described in item 22, characterized in that,

the image characteristic information includes at least one of a sum of absolute-values of differences of signal values between the pixels in the predetermined area, a variance of signal value of each pixel in the predetermined area and a standard deviation of signal value of each pixel in the predetermined area.

(26) The image-processing apparatus, described in item 23, characterized in that,

the image characteristic information includes at least one of a sum of absolute-values of differences of signal values between the pixels in the predetermined area, a variance of signal value of each pixel in the predetermined area and a standard deviation of signal value of each pixel in the predetermined area.

(27) The image-processing program, described in item 24, characterized in that,

the image characteristic information includes at least one of a sum of absolute-values of differences of signal values between the pixels in the predetermined area, a variance of signal value of each pixel in the predetermined area and a standard deviation of signal value of each pixel in the predetermined area.

According to the invention described in items 2, 9, 16 and 25-27, easy derivation of image characteristic information as well as high performance image processing can be achieved.

(28) The image-processing method, described in item 22 or 25, characterized in that, the method includes:

a filter selecting process for selecting a spatial filter to be employed for the sharpness-enhancement processing out of a plurality of spatial filters, which are different relative to each other in terms of relationships between image-edge directions and edge-enhancing degrees, based on the image characteristic information; and

the sharpness-enhancement processing is conducted in the image-processing process by using the selected spatial filter.

(29) The image-processing apparatus, described in item 23 or 26, characterized in that, the apparatus is provided with:

a filter selecting section for selecting a spatial filter to be employed for the sharpness-enhancement processing out of a plurality of spatial filters, which are different relative to each other in terms of relationships between image-edge directions and edge-enhancing degrees, based on the image characteristic information; and

the image-processing section conducts the sharpness-enhancement processing by using the selected spatial filter.

(30) The image-processing program, described in item 24 or 27, characterized in that, the image-processing program realizes:

a filter selecting function for selecting a spatial filter to be employed for the sharpness-enhancement processing out of a plurality of spatial filters, which are different relative to each other in terms of relationships between image-edge directions and edge-enhancing degrees, based on the image characteristic information; and,

when realizing the image-processing function, the sharpness-enhancement processing is conducted by using the selected spatial filter.

According to the invention described in items 3, 10, 17 and 28-30, a spatial filter used for sharpness enhancement is selected in response to image characteristic information. This arrangement provides a preferable sharpness-enhancement effect conforming to each area in the image.

(31) An image-processing method, characterized in that,

in the image-processing method for applying a sharpness-enhancement processing to an input image and outputting, the method includes:

a deriving process for deriving image characteristic information of a predetermined area from information of pixels residing in a vicinity of an image-processing object pixel and residing in the predetermined area, which do not include the image-processing object pixel;

a filter selecting process for selecting a spatial filter to be employed for the sharpness-enhancement processing out of a plurality of spatial filters, which are different relative to each other in terms of relationships between image-edge directions and edge-enhancing degrees, based on the image characteristic information; and

an image-processing process for applying the sharpness-enhancement processing to the image-processing object pixel, based on the image characteristic information derived.

(32) An image-processing apparatus, characterized in that,

in the image-processing apparatus, which applies a sharpness-enhancement processing to an input image and outputs, the image-processing apparatus is provided with:

a deriving section to derive image characteristic information of a predetermined area from information of pixels residing in a vicinity of an image-processing object pixel and residing in the predetermined area, which do not include the image-processing object pixel;

a filter selecting section to select a spatial filter to be employed for the sharpness-enhancement processing out of a plurality of spatial filters, which are different relative to each other in terms of relationships between image-edge directions and edge-enhancing degrees, based on the image characteristic information; and

an image-processing section to apply the sharpness-enhancement processing to the image-processing object pixel, based on the image characteristic information derived.

(33) An image-processing program for making a computer, for conducting image processing, to realize:

a deriving function for deriving image characteristic information of a predetermined area from information of pixels residing in a vicinity of an image-processing object pixel and residing in the predetermined area, which do not include the image-processing object pixel;

a filter selecting function for selecting a spatial filter to be employed for the sharpness-enhancement processing out of a plurality of spatial filters, which are different relative to each other in terms of relationships between image-edge directions and edge-enhancing degrees, based on the image characteristic information; and

an image-processing function for applying the sharpness-enhancement processing to the image-processing object pixel, based on the image characteristic information derived.

According to the invention described in items 4, 11, 18 and 31-33, a spatial filter used for sharpness enhancement can be used in response to image characteristic information. This arrangement provides a preferable sharpness-enhancement effect conforming to each area in the image.

(34) The image-processing method, described in item 31, characterized in that,

in the deriving process, the image of an processing object is converted with a multi-resolution conversion, and then, the image characteristic information are derived from a plurality of decomposed images generated by the multi-resolution conversion.

(35) The image-processing apparatus, described in item 32, characterized in that

the deriving section converts the image of an processing object with a multi-resolution conversion, and then, derives the image characteristic information from a plurality of decomposed images generated by the multi-resolution conversion.

(36) The image-processing program, described in item 33, characterized in that,

when realizing the deriving function, the image of an processing object is converted with a multi-resolution conversion, and then, the image characteristic information are derived from a plurality of decomposed images generated by the multi-resolution conversion.

According to the invention described in items 5, 12, 19 and 34-36, the decomposed image generated by multi-resolution conversion processing is used to derive the image characteristic information, thereby getting the image characteristic information with consideration given to the broader perspective of the image structure.

(37) The image-processing method, described in item 34, characterized in that,

in the deriving process, a Dyadic Wavelet transform is employed in an image-decomposing process at a level higher than at least level 2 of the multi-resolution conversion processing, and then, information, in regard to edges included in the image, are derived from the plurality of decomposed images generated by the Dyadic Wavelet transform, as the image characteristic information.

(38) The image-processing apparatus, described in item 35, characterized in that

the deriving section employs a Dyadic Wavelet transform in an image-decomposing process at a level higher than at least level 2 of the multi-resolution conversion processing, and then, derives information, in regard to edges included in the image, from the plurality of decomposed images generated by the Dyadic Wavelet transform, as the image characteristic information.

(39) The image-processing program, described in item 36, characterized in that

when realizing the deriving function, a Dyadic Wavelet transform is employed in an image-decomposing process at a level higher than at least level 2 of the multi-resolution conversion processing, and then, information, in regard to edges included in the image, are derived from the plurality of decomposed images generated by the Dyadic Wavelet transform, as the image characteristic information.

According to the invention described in items 6, 13, 20 and 37-39, a Dyadic Wavelet transform is employed in multi-resolution conversion processing, thereby providing higher-precision image characteristic information and hence ensuring higher-precision image processing.

(40) The image-processing method, described in item 31 or 34, characterized in that,

in the deriving step, information, representing a dispersion degree of signal values of plural pixels residing on positions being substantially equidistant from the image-processing object pixel in the predetermined area, are derived as the image characteristic information.

(41) The image-processing apparatus, described in item 32 or 35, characterized in that

the deriving section, derives information, representing a dispersion degree of signal values of plural pixels residing on positions being substantially equidistant from the image-processing object pixel in the predetermined area, as the image characteristic information.

(42) The image-processing program, described in item 33 or 36, characterized in that,

when realizing the deriving function, information, representing a dispersion degree of signal values of plural pixels residing on positions being substantially equidistant from the image-processing object pixel in the predetermined area, are derived as the image characteristic information.

According to the invention described in items 7, 14, 21 and 40-42, the image characteristic information can be obtained without complicated calculation and easy selection of a spatial filter is ensured, with the result that noiseless sharpness-enhancement effect is easily obtained.

### BRIEF DESCRIPTION OF THE DRAWINGS

Other objects and advantages of the present invention will become apparent upon reading the following detailed description and upon reference to the drawings in which:

FIG. 1 is a block diagram representing the configuration of an image processing system 100 of the present invention;

FIG. 2(a) and FIG. 2(b) are diagrams explaining the processing of the spatial filter used for sharpness-enhancement processing;

FIG. 3 is a diagram using the function f{x} to represent the LUT used for sharpness-enhancement processing;

FIG. 4(a), FIG. 4(b) and FIG. 4(c) are diagrams representing an example of a method for filter selection in the first embodiment of the present invention (filter selection method <1>);

FIG. 5(a), FIG. 5(b) and FIG. 5(c) are diagrams representing an example of a method for filter selection in the first embodiment (filter selection method <2>);

FIG. 6 is a flowchart showing the flow of image processing as a whole implemented in the image processing system 100;

FIG. 7 is a flowchart representing the sharpness-enhancement processing in Step S7 of FIG. 6;

FIG. 8(a), FIG. 8(b), FIG. 8(c), FIG. 8(d), FIG. 8(e) FIG. 8(f), FIG. 8(g), FIG. 8(h) and FIG. 8(i) are diagrams explaining the characteristics of a spatial filter used in the present invention;

FIG. 9 is a diagram representing an example of applying the spatial filter shown in FIGS. 8(a)-8(i);

FIG. 10 is a flowchart showing the flow of sharpness-enhancement processing in the second embodiment of the present invention;

FIG. 11(a) and FIG. 11(b) are diagrams representing an example of a method for filter selection in the second embodiment of the present invention;

FIG. 12 is a diagram representing an example of a method for filter selection in the second embodiment;

FIG. 13 is a diagram representing a wavelet function used for image signal edge detection in an example of a variation in the second embodiment;

FIG. 14 is a system block diagram representing the filter processing by the wavelet transform on level 1;

FIG. 15 is a system block diagram representing the filter processing by the wavelet transform on level 1 in the 2D signal;

FIG. 16 is a schematic diagram showing the process of an input signal So being decomposed by wavelet transform on level 3;

FIG. 17 is a system block diagram representing a method for reconstructing the signal in the state prior to decomposition through filter processing by wavelet inverse transform;

FIG. 18 is a diagram representing the waveform of the input signal So and the waveform of a corrected high-frequency band component W·γ on each level obtained by wavelet transform;

FIG. 19 is a system block diagram showing the filter processing by Dyadic Wavelet transform on level 1 in the 2D signal;

FIG. 20 is a system block diagram showing the filter processing by Dyadic Wavelet inverse transform on level 1 in the 2D signal;

FIG. 21 is a system block diagram representing the process from the Dyadic Wavelet transform for the input signal So to the acquisition of image-processed signal So′; and

FIG. 22 is a flowchart showing the sharpness-enhancement processing in an example of a variation of the second embodiment.

### DETAILED DESCRIPTION OF THE PREFERRED EMBODIMENT

The following describes the preferred embodiments of the present invention with reference to drawings:

[Embodiment 1]

The following describes the configuration:

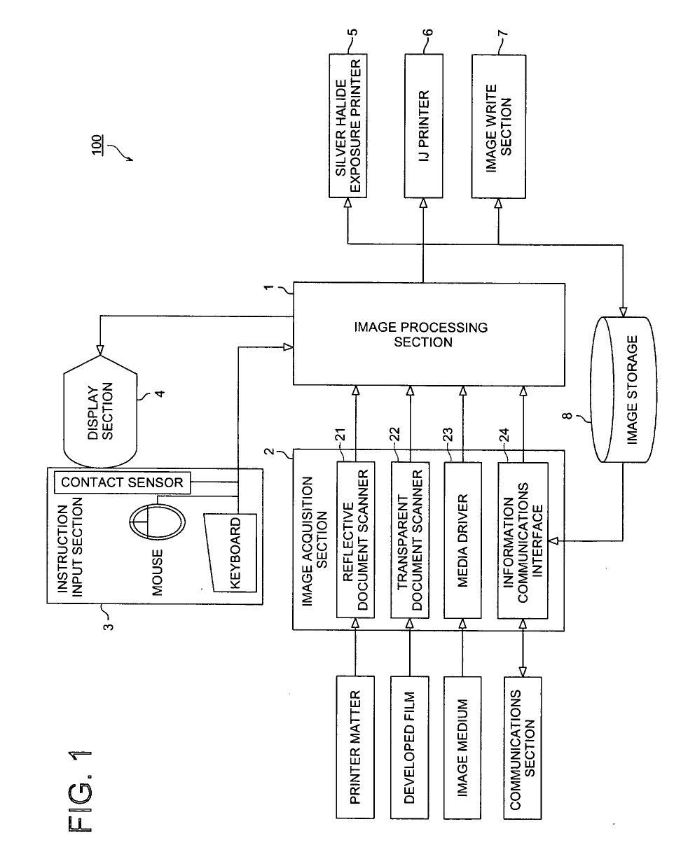

FIG. 1 shows the configuration of an image processing system 100 as a first embodiment of the present invention: As shown in FIG. 1, the image processing system 100 is provided with an image processing section 1, image acquisition section 2, instruction input section 3, display section 4, silver halide exposure printer 5, IJ (Ink-Jet) printer 6, image write section 7 and image storage 8.

The image processing section 1 includes a microcomputer and controls the operations of various parts constituting the image processing system 100 through collaboration between various control programs such as image processing program stored in the memory section (not shown in the drawings) including a ROM (Read Only Memory) and a CPU (Central Processing Unit) (not shown in the drawings). The following describes the control operation of the image processing section 1:

Based on the input signal (command information) from the instruction input section 3, the image processing section 1 applies various forms of image processing to the image signal acquired from the image acquisition section 2. Image processing applied by the image processing section 1 includes brightness adjustment, color tone adjustment, contrast adjustment, color saturation adjustment, sharpness adjustment, granularity adjustment, dodging adjustment, and under-exposure correction.

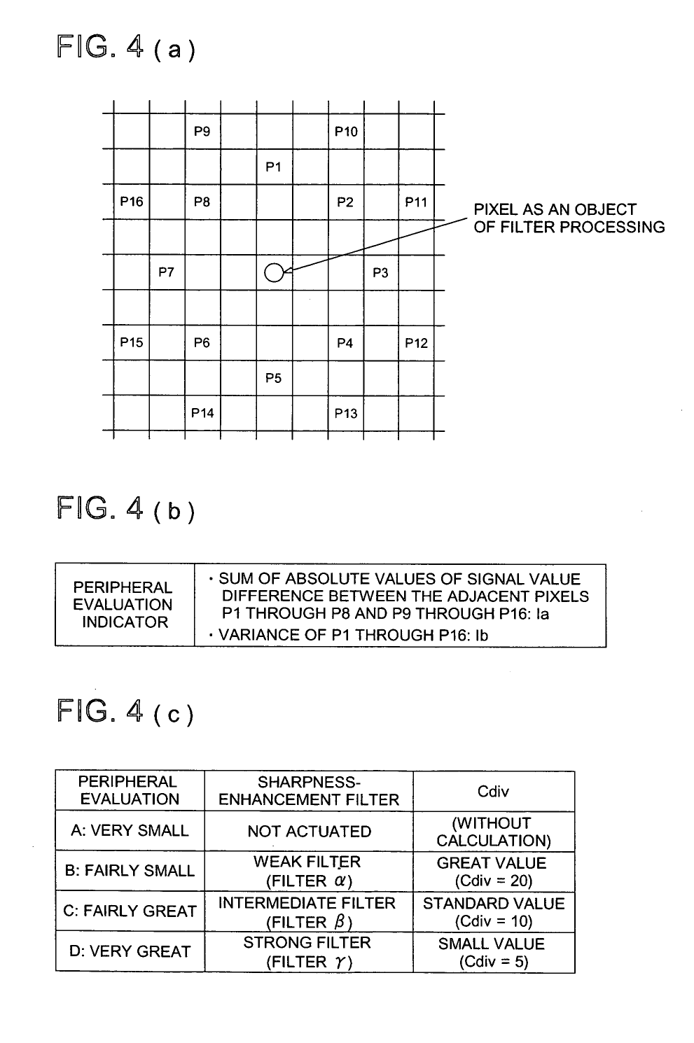

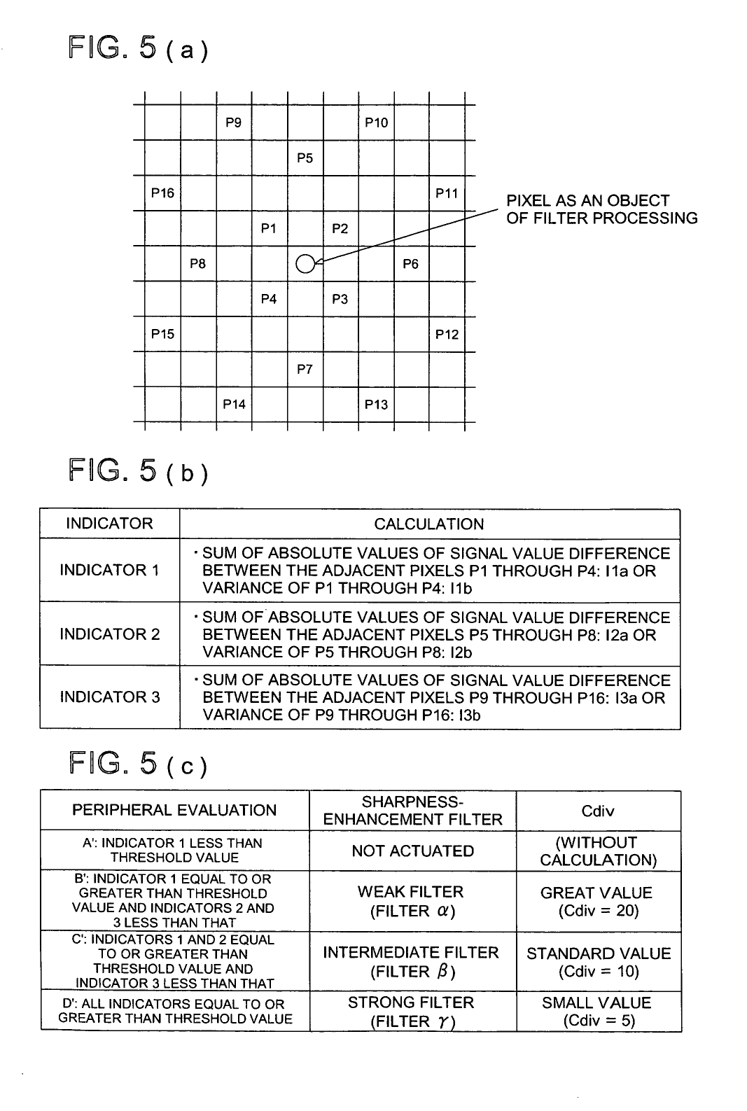

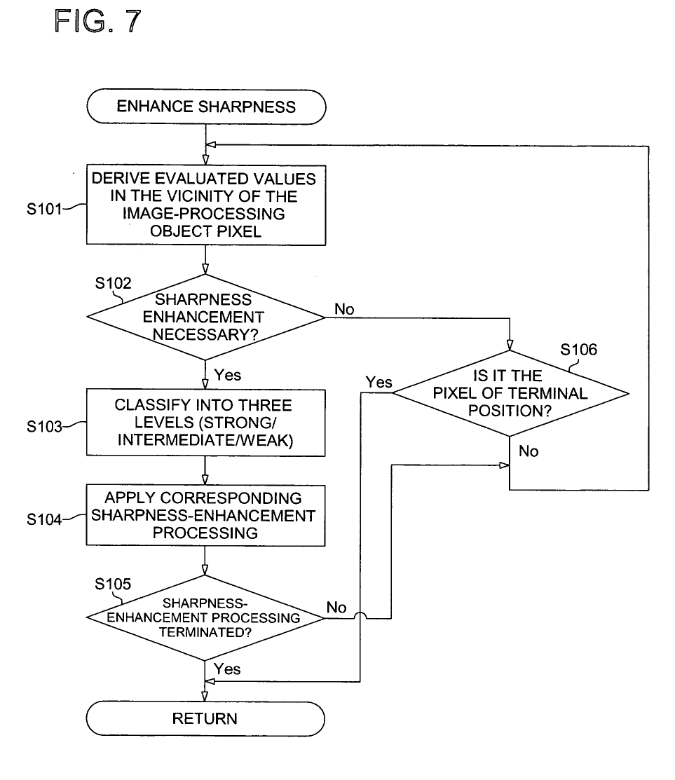

The image processing section 1 in the present invention is located in the vicinity of an image-processing object pixel, and gets the image characteristic information of the predetermined area from a plurality of pixels residing in a predetermined area not containing the image-processing object pixel. Based on this image characteristic information, the image processing section 1 applies sharpness-enhancement processing to the image-processing object pixel (FIG. 7). The image characteristics include at least one of the sum of absolute values of the signal value differences between the adjacent pixels in the predetermined area, a variance of each signal value of the adjacent pixels residing in the predetermined area, and a standard deviation of each signal value of the adjacent pixels (FIGS. 4(a)-4(c) and FIGS. 5(a)-5(c)).

In sharpness-enhancement processing, based on the image characteristic information of the predetermined area, the image processing section 1 selects (determines) the spatial filter used for sharpness-enhancement processing, out of a plurality of the spatial filters having different filtering intensities. Details of sharpness-enhancement processing and spatial filter selection method will be described later.

The image processing section 1 applies conversion processing (color conversion) conforming to the form of output to the processed image signal, and outputs the resulting signal. The destination for output from the image processing section 1 includes a silver halide exposure printer 5, IJ printer 6, image write section 7 and image storage 8.

The image acquisition section 2 consists of a reflective document scanner 21, transparent document scanner 22, media driver 23 and information communications interface 24.

The reflective document scanner 21 consists of a light source, CCD (Charge-Coupled Device) and analog-to-digital converter. Light coming from the light source is applied to the document (photographic print, text/image data and various printed matters) carried by the document setting glass, and the reflected light is converted into the electric signal (analog signal) by the CCD. This analog signal is converted into digital signal by the analog-to-digital converter, whereby the digital image signal is acquired. The transparent document 22 scans such a transparent document as a developed negative film and positive film, and receives the digital image signal.

The media driver 23 can be loaded with such media as a CD-R, memory stick (registered trademark), smart media (registered trademark), Compact Flash (registered trademark), multimedia card (registered trademark), SD memory card (registered trademark) and PC card. The media driver 23 scans the digital image signal recorded in these media.

The information communications interface 24 is an interface for connection between the computer that can be linked with a communications network such as the LAN (Local Area Network) and Internet, and the image processing system 100. The information communications interface 24 receives the image signal representing the photographic image and print command signal, from another computer connected through the communications network.

The instruction input section 3 is equipped with a keyboard and mouse. The operation signal generated by the operation of the keyboard and mouse is outputted to the CPU of the image processing section 1. The instruction input section 3 is equipped with a touch panel (contact sensor) provided in an overlapped form so as to cover the display screen of the display section 4. The touch panel detects the coordinate specified by touching according to the electromagnetic inductive, magnetostrictive or pressure sensitive scanning principle, and outputs the detected coordinate in the form of a position signal to the CPU of the image processing section 1.

The display section 4 has a display screen composed of an LCD (liquid crystal display), and provides a predetermined display according to the display control signal inputted by the CPU of the image processing section 1.

The silver halide exposure printer 5 produces image information for exposure from the image signal generated by the image processing section 1, and exposes the image on a photosensitive material, based on the generated image information for exposure. The exposed photosensitive material is developed, dried and outputted. Based on the image signal generated by the image processing section 1, the IJ printer 6 produces a printed output according to the ink jet method. The image write section 7 is designed to permit mounting of various types of media, and the image signal generated by the image processing section 1 is recorded on the mounted media.

The image storage 8 stores the image signal processed by the image processing section 1. The image signal stored in the image storage 8 can be reused as an image source.

<Sharpness-Enhancement Processing>

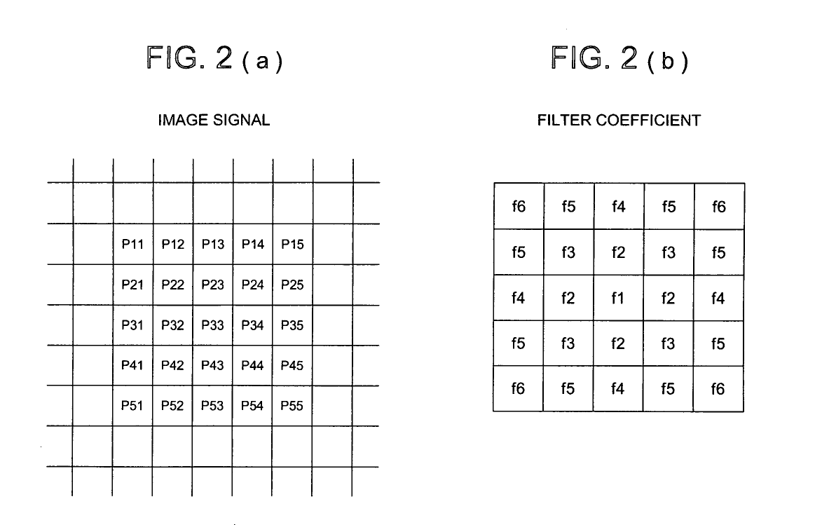

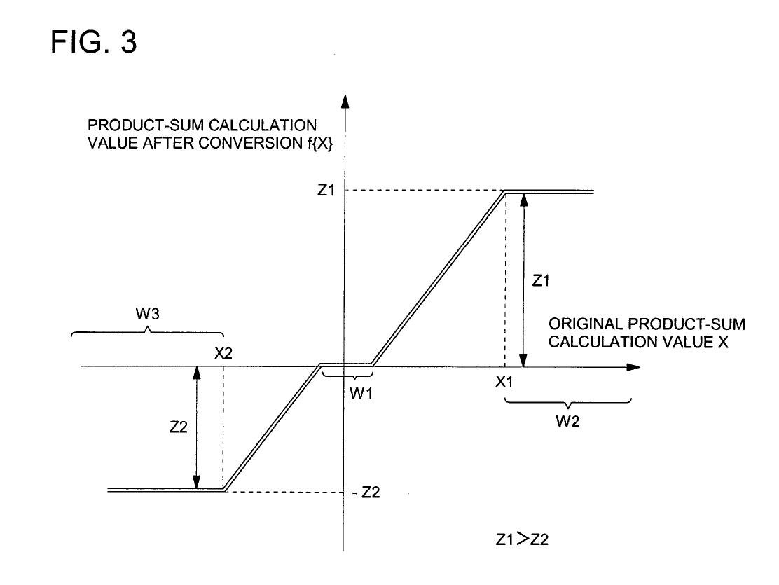

Referring to FIGS. 2(a)-2(b) and FIG. 3, the following describes the sharpness-enhancement processing implemented by the image processing section 1. In the first embodiment (and the second embodiment to be described later), the calculation area of the spatial filter used for sharpness-enhancement processing has a size of 5 by 5 pixels. FIG. 2(a) shows actual image signal values (P11 through P55). FIG. 2(b) shows the filter coefficients (f1 through f6) of the spatial filter used for sharpness-enhancement processing.

When the pixels (signal value=P33) located at the center of the filter calculation area is assumed as an image-processing object pixel, the processed signal value P33′ can be expressed by the following formula (1), using the filter coefficient given in FIG. 2(b):

$$\begin{matrix}[ Mathematical Formula 1 ] \\ {P33}^{′} = P33 + f \{ P33 \times f1 + ( P23 + P32 + P43 + P34 ) \times f2 + \\ ( P22 + P24 + P42 + P44 ) \times f3 + \\ ( P13 + P31 + P35 + P53 ) \times f4 + \\ ( P12 + P14 + P25 + P45 + P54 + P52 + P41 + P21 ) \times \\ f 5 + ( P11 + P15 + P51 + P55 ) \times f6 \} / Cdiv\end{matrix} \qquad ( 1 )$$

where Cdiv denotes the coefficient for adjusting the intensity of the spatial filter. The greater the Cdiv, the weaker the effect of the spatial filter. Further, the following formula (2) holds for filter coefficients (f1 through f6):

[Mathematical Formula 2]

f1+4×(f2+f3+f4+2×f5+f6)=0 (2)

If the formula (2) holds for filter coefficients (f1 through f6), f{X} is set such that f{X=0}=0 (i.e. P33′=P33) when all values for P11 through P55 are the same.

The LUT (Look-Up Table) used for sharpness-enhancement processing can be represented as the function f{X} shown in Formula (1). FIG. 3 is a graphical representation of the function f{X}. In FIG. 3, the horizontal axis X represents the sum of product of the signal value before conversion by the LUT (in the { } of Formula (1)). The vertical axis f{X} denotes the value of X having been converted by the LUT. The positive area of f{X} is where the image-processing object pixel is brightened by the action of f{X}, while the negative area of f{X} is where the image-processing object pixel is darkened by the action of f{X}.

In FIG. 3, the converted value is 0 in the area W1 in the vicinity of X=0. This is intended to ensure that the effect of sharpness-enhancement processing does not affect the minute change of the original signal. For example, it has the following effect: Computer graphic gradation representation is made smooth by ensuring that the filter does not sense the change of the minimum pit. Further, if there is a slight noise, it is not enhanced.

In FIG. 3, the area where the converted value f{X} is not changed is present in area W2 where X is equal to or greater than X1 and in area W3 where X is equal to or smaller than X2. This has the advantage of preventing a strong noise such as noise at an isolated point from being excessively enhanced. It is particularly effective when one wishes to have a strong effect of sharpness-enhancement processing.

Let us assume that the value f{X} in area W2 is Z1, and the value f{X} in area W3 is −Z2 (Z1, Z2>0). Then it is preferred that Z1>Z2. This is particularly preferred when an image is formed by digital exposure of the negative type silver halide photosensitive material. To put it another way, bleeding is caused by a slight light leakage or scattering at the time of exposure of the photosensitive material. In the recording medium where an image is formed by the dye being colored by exposure to light, the minute structure of white is more like to be blurred than that of black, when subjected to bleeding of light. Thus, if the limiting value Z1 of the positive area of f{X} is set at a higher level, the effect of enhancing the minute structure of white is increased. Further, limiting value −Z2 of the negative area of f{X} is set at a lower level, excessive enhancement of the minute structure of black is suppressed, with the result that the effect of well-balanced sharpness-enhancement processing is obtained.

<Filter Strength>

The following describes the strength of the spatial filter used for sharpness-enhancement processing in the first embodiment: In FIG. 2(b), assume that f1=24 and f2 through f6=−1, and a filter having Cdiv=20 is a spatial filter α. Further, assume that f1=24 and f2 through f6=−1, and a filter having Cdiv=10 is a spatial filter β. Further, assume that f1=24 and f2 through f6=−1, and a filter having Cdiv=5 is a spatial filter γ. The spatial filters α, β and γ have a common filter coefficient, but different values Cdiv. Also assume that f1=48 and f2 through f6=−2, and a filter having Cdiv=10 is a spatial filter δ.

The Cdiv of the spatial filter β is half that of the spatial filter α; therefore, spatial filter β the value of the second term on the right side of Formula (1) is twice that of the spatial filter α. Accordingly, the strength of the spatial filter β is a little more than twice that of the spatial filter α. In the same way, the Cdiv of spatial filter γ is half that of the spatial filter β, so the strength of the spatial filter γ is twice that of the spatial filter β. In the case of the spatial filter δ, the value Cdiv is the same as that of the spatial filter β, but the filter coefficient is twice that of the spatial filter β. Accordingly, in the case of spatial filter δ, the value of the second term on the right side of Formula (1) is twice that of the spatial filter β. Thus, the strength of the spatial filter δ is twice that of the spatial filter β.

Sharpness-enhancement processing in the first embodiment employs three types of spatial filters having different intensities (strong, intermediate and weak). They will be called “strong filter”, “intermediate filter” and “weak filter”, respectively. For example, in the spatial filters α, β and γ having a common filter coefficient and different values of Cdiv, the spatial filter α corresponds to the weak filter, the spatial filter β the intermediate filter, and the spatial filter γ the strong filter.

<Filter Selection Method>

The following describes the spatial filter selection method (filter strength selection method) in the first embodiment: In the first embodiment, the strength of the spatial filter is determined based on the information of specific pixels (hereinafter referred to as “sampling points”) residing in the vicinity (periphery) of the image-processing object pixel, without containing an image-processing object pixel.

Referring to FIG. 4(a), FIG. 4(b) and FIG. 4(c), the filter selection method <1> will be described. As shown in FIG. 4(a), sixteen pixels residing in the periphery of the image-processing object pixel, without containing an image-processing object pixel, are assumed as sampling points and the signal values of these sampling points are assigned with P1 through P16, respectively. As shown in FIG. 4(b), the sum of absolute values Ia of the signal value difference between the adjacent pixels in a sampling point and the variance Ib of the signal value of the sampling point will be used as image characteristic information (hereinafter referred to as “peripheral evaluation”) serving as an indicator in the selection of a spatial filter. In other words, Ia and Ib are represented by Formulas (3) and (4), respectively.

$$\begin{matrix}\begin{matrix}[ Mathematical Formula 3 ] \\ I a = \vert P1 - P2 \vert + \vert P2 - P3 \vert + \vert P4 - P5 \vert + \\ \vert P5 - P6 \vert + \vert P6 - P7 \vert + \vert P7 - P8 \vert + \vert P8 - P1 \vert + \\ \vert P9 - P10 \vert + \vert P10 - P11 \vert + \vert P11 - P12 \vert + \vert P12 - P13 \vert + \\ \vert P13 - P14 \vert + \vert P14 - P15 \vert + \vert P15 - P16 \vert + \vert P16 - P9 \vert\end{matrix} & ( 3 ) \\ I b = \frac{1}{16} {\sum }_{i = 1}^{16} {( P i - P0 )}^{2} & ( 4 )\end{matrix}$$

where PO in Formula (4) denotes the average value of the signal values of the pixels in the area with sampling points contained therein.

According to the value of Ia (or Ib) having been calculated, the peripheral evaluation standard is classified into four levels (A, B, C and D), and the spatial filter used for sharpness-enhancement processing is selected according to the evaluation value. FIG. 4(c) shows the relationship between peripheral evaluation value and spatial filter to be used. As shown in FIG. 4(c), level A is assigned when the indicator Ia (or Ib) for peripheral evaluation is “very small”; level B when it is “fairly small”; level C when it is “fairly great”; and level D when it is “very great”. For example, assume that Ia shown in Formula (3) is used as the indicator of the peripheral evaluation, and the values for identifying the magnitude of the Ia are g1, g2 and g3 (g1<<g2<<g3). Then level A can be assigned when g1>Ia; level B when g1≦Ia≦g2; level C when g2≦Ia<g3; and level D when g3≦Ia.

As shown in FIG. 4(c), when the peripheral evaluation level is A (very small), there is almost no change in the signal on the periphery of image-processing object pixel; therefore, the spatial filter for sharpness enhancement is not actuated. When the peripheral evaluation level is B (fairy small), a weak filter (spatial filter a) is selected. When the peripheral evaluation level is C (fairy great), an intermediate filter (spatial filter β) is selected. When the peripheral evaluation level is D (very great), a strong filter (spatial filter γ) is selected.

In the filter selection method shown in FIG. 4(a), FIG. 4(b) and FIG. 4(c), peripheral evaluation values (A, B, C and D) are determined based on the sum of absolute values Ia of the signal value difference between the adjacent pixels in sampling point or the variance Ib of the signal value of the sampling point. However, it is also possible to arrange such a configuration that evaluation value is determined based on the standard deviation of signal value at the sampling point.

The method of fixing the sampling point and peripheral evaluation criteria for the selection of the spatial filter used for sharpness-enhancement processing are not restricted to the filter selection method <1> shown in FIGS. 4(a)-4(c). For example, it is also possible to make such arrangements that the frequency of sampling and sampling point are determined in conformity to the parameter related to the image sampling resolution, the print output resolution at the time of printing, image enlargement rate, image reproduction and MTF (Modulation Transfer Function) for observation. Referring to FIGS. 5(a)-5(c), the following describes a variation of the filter selection method (filter selection method <2>):

As shown in FIG. 5(a), sixteen pixels residing in the periphery of the image-processing object pixel, without containing an image-processing object pixel, are assumed as sampling points and the signal values of these sampling points are assigned with P1 through P16, respectively. As shown in FIG. 5(b), peripheral evaluation indicators are classified into three levels (indicators 1 through 3).

The sum of absolute values I1a of the signal value difference between the adjacent pixels in four pixels closest to the image-processing object pixel, out of sixteen sampling points, or the variance I1b of the signal value of four pixels is used as the indicator 1. The sum of absolute values I2a of the signal value difference between the adjacent pixels in four pixels the second closest to the image-processing object pixel, out of sixteen sampling points, or the variance I2b of the signal value of these four pixels is used as the indicator 2. The sum of absolute values I3a of the signal value difference between the adjacent pixels in eight pixels the farthest away from the image-processing object pixel, out of sixteen sampling points, or the variance I3b of the signal value of these four pixels is used as the indicator 3.

In other words, I1a and I1b in indicator 1, I2a and I2b in indicator 2 and I3a and I3b in indicator 3 can be expressed by the following formulas (5) through (10).

$$\begin{matrix}\begin{matrix}\begin{matrix}[ Mathematical Formula 4 ] \\ Indicator 1 \text{:}\end{matrix} \\ I1a = \vert P1 - P2 \vert + \vert P2 - P3 \vert + \vert P3 - P4 \vert + \vert P4 - P1 \vert\end{matrix} & ( 5 ) \\ I1b = \frac{1}{4} {\sum }_{i = 1}^{4} {( P i - P0 )}^{2} & ( 6 ) \\ \begin{matrix}Indicator 2 \text{:} \\ I2a = \vert P5 - P6 \vert + \vert P6 - P7 \vert + \vert P7 - P8 \vert + \vert P8 - P5 \vert\end{matrix} & ( 7 ) \\ I2b = \frac{1}{4} {\sum }_{i = 5}^{8} {( P i - P0 )}^{2} & ( 8 ) \\ \begin{matrix}Indicator 3 \text{:} \\ I3a = \vert P9 - P10 \vert + \vert P10 - P11 \vert + \vert P11 - P12 \vert + \vert P12 - P13 \vert \\ \vert P13 - P14 \vert + \vert P14 - P15 \vert + \vert P15 - P16 \vert + \vert P16 - P9 \vert\end{matrix} & ( 9 ) \\ I3b = \frac{1}{8} {\sum }_{i = 9}^{16} {( P i - P0 )}^{2} & ( 10 )\end{matrix}$$

where PO in formulas (6), (8) and (10) denotes the average value of the signal value of the pixels in the area with sampling points therein.

In the filter selection method <2>, the peripheral evaluation standard is classified into four levels (′A, B′, C′ and D′), and the spatial filter used for sharpness-enhancement processing is selected according to the values of indicators 1 through 3. FIG. 5(c) shows the relationship between peripheral evaluation value and spatial filter to be used. As shown in FIG. 5(c), level A′ is assigned when the indicator 1 is less than threshold value; level B′ when the indicator 1 is not less than the threshold value and indicators 2 and 3 are less than threshold value; level C′ when the indicators 1 and 2 are not less than the threshold value and indicator 3 is less than threshold value; and level D′ when all indicators are not less than the threshold value.

As shown in FIG. 5(c), when the peripheral evaluation level is A′, there is almost no change in the signal closest to the image-processing object pixel; therefore, the spatial filter for sharpness enhancement is not actuated. When the peripheral evaluation level is B′, a weak filter (spatial filter α) is selected. When the peripheral evaluation level is C′, an intermediate filter (spatial filter β) is selected. When the peripheral evaluation level is D′, a strong filter (spatial filter γ) is selected.

In the filter selection method <2> shown in FIGS. 5(a)-5(c), peripheral evaluation values (A′, B′, C′ and D′) are determined based on the sum of absolute values I1a through I3a of the signal value difference between the adjacent pixels in sampling points or the variances I1b through I3b of the signal value of the sampling points. However, it is also possible to arrange such a configuration that evaluation value is determined based on the standard deviation of signal value at the sampling point.

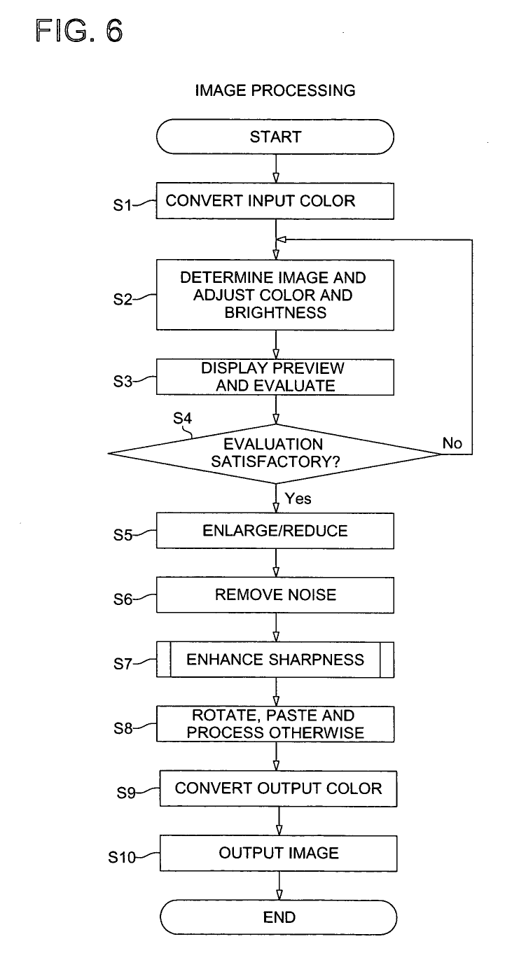

The following describes the operation in the first embodiment: In the first place, the flow of the entire image processing in the image processing system 100 will be described with reference to the flowchart of FIG. 6.

Input color conversion conforming to the attribute is applied to the image information (image signal) acquired from the reflective document scanner 21, transparent document scanner (film scanner) 22 and other medium devices (Step S1). The input color conversion in Step S1 includes the process of converting the signal value into the meaningful unit system as an image signal such as a visual signal value and optical density value, image signal wherein the aforementioned signal value is obtained by digitization of the amount of light passing through the film and having been received by the sensor. The input color conversion in Step S1 also includes the process of matching the color tone represented conforming to each spectral characteristic, to the standard color space.

Then the acquired image signal is evaluated (Step S2). This is the process to be carried out when the acquired image signal has the brightness and color tone that fail to meet the requirements. Namely, in this case, the system automatically obtains the amount of gradation adjustment very close to the correct amount in advance in order to ensure that the a subsequent adjustment by the user will be carried out easily. The amount of gradation adjustment obtained in this step is integrated with the adjustment added by the operator and is represented in terms of parameters for the adjustment of color, brightness and contrast.

After the color, brightness and contrast have been adjusted by the automatic operation and manual operation by the operator, the color image is displayed on the display screen of the display section 4, and the image displayed on the screen is evaluated by the operator (Step S3). In image evaluation, when the adjustment key has been depressed, evaluation is made to determine that the further adjustment of the image signal is necessary (No in Step S4). The system goes back to Step S2, and the color, brightness and contrast of this image signal is adjusted again by the automatic operation and manual operation by the operator.

If the result of image evaluation is satisfactory after the operation of the key on the instruction input section 3 (Yes in Step S4), image enlarge/reduce processing (Step S5), noise elimination processing (Step S6) and sharpness enhancement processing (Step S7, details in FIG. 7) are applied to the image signal as an object of image processing. This image signal undergoes processing of image rotation, pasting and overlaying, whereby finished image information is obtained (Step S8).

When image enlarge/reduce processing, noise elimination, image rotation, pasting and overlaying are applied, the order or processing is different according to the contents to be processed. Further, when the image is displayed on the screen and contrast is adjusted on the actual image processing system 100, a small image for preview is used instead of a large final image. When the result of evaluation is satisfactory, processing of the final image is performed again.

When the image signal having been processed is printed out, this image signal undergoes processing of gradation conversion to color space conforming to the characteristics of a printer (Step S9), and is outputted to a specified printer (Step S10), and image processing exits.

The following describes the sharpness-enhancement processing shown in Step S7 of FIG. 6 with reference to FIG. 7. The following flowchart shows the case where the filter selection method <1> of FIGS. 4(a)-4(c) is used. The same processing as that of FIG. 7 is also applied when the filter selection method <2> shown in FIGS. 5(a)-5(c) is used.

As shown in the filter selection method <1> shown in FIGS. 4(a)-4(c), Ia or Ib in the vicinity of the image-processing object pixel is calculated and peripheral evaluation values (A, B, C and D) are derived based on the calculated Ia or Ib (Step S101). Based on the evaluation value derived in Step S101, a decision is made to see whether or not sharpness-enhancement processing must be applied to image-processing object pixel (Step S102).

In Step S102, when the peripheral evaluation value is “A”, a decision is made that sharpness-enhancement processing is not required (NO in Step S102). Evaluation is made to determine whether or not the pixel as an object of processing at present is the last one (pixel of the terminal portion) in terms of the order of processing (Step S106).

In Step S106, if a decision is made that the image-processing object pixel is the final one (YES in Step S106), the sharpness-enhancement processing exits. In Step S106, if a decision is made that the image-processing object pixel is not the final one (NO in Step S106), the system goes back to Step S101, and a peripheral evaluation value is derived for the next pixel as an object for image-processing.

In Step S102, if the peripheral evaluation value is any one of B, C and D, a decision is made that sharpness-enhancement processing is necessary (YES in Step S102), and the type of the spatial filter (strong, intermediate or weak) used for sharpness-enhancement processing is determined in conformity to the evaluation value (Step S103).

Sharpness-enhancement processing by the spatial filter determined in the (Step S103) is applied to the image-processing object pixel (Step S104). Upon completion of sharpness-enhancement processing, evaluation is made to determine whether or not the pixel having undergone sharpness-enhancement processing is the last one in terms of the order of processing, namely, whether or not sharpness-enhancement processing has been terminated (Step S105).

In Step S105, if it has been determined that all the sharpness-enhancement processing has not yet terminated (NO in Step S105), the system goes to Step S101, and peripheral evaluation values for the pixel as the next object for processing are derived. In Step S105, if it has been determined that all the sharpness-enhancement processing has been terminated (YES in Step S105), the sharpness-enhancement processing exits.

As described above, the image processing section 1 in the first embodiment is designed in such a way that sharpness-enhancement processing is performed based on the conditions of the pixels residing in the periphery without containing an image-processing object pixel. This arrangement permits sharpness to be enhanced while suppressing the enhancement of image noise tending to be conspicuous in image processing, such as an insolated point. To put it another way, even when the image-processing object pixel itself is an isolated point noise, its peripheral evaluation value does not include the value for the image-processing object pixel; therefore, there is a very low possibility that noise is made conspicuous by excessive sharpness enhancement. Accordingly, when the portrait image undergoes sharpness enhancement, a high degree of sharpness enhancement is applied to the flat portion of the skin, whereby a sufficient sharpness enhancement is applied to the portion having an image structure such as the face profile or hair while preventing the adverse effect of the skin being reproduced as a rough skin.

[Embodiment 2]

The following describes the second embodiment of the present invention: In the aforementioned first embodiment, a peripheral evaluation value is derived based on the sum of absolute values of the signal value difference between the adjacent pixels in the sampling pixels residing in the periphery without containing an image-processing object pixel and the variance of the signal value of the sampling pixel. A spatial filter is selected based on the evaluation value. In the present second embodiment, the spatial filter is selected by evaluating the direction of the edge in the peripheral area in addition to the sum of absolute values of the signal value difference or the variance.

The configuration of the second embodiment will be described first. The configuration of the image processing section in the second embodiment is the same as that of the image processing system 100 shown in FIG. 1. Accordingly, the same numerals of reference will be assigned, and illustration will be omitted. In the following description of the configuration, the portion (image processing section 1) different from the image processing system 100 in the first embodiment will be described.

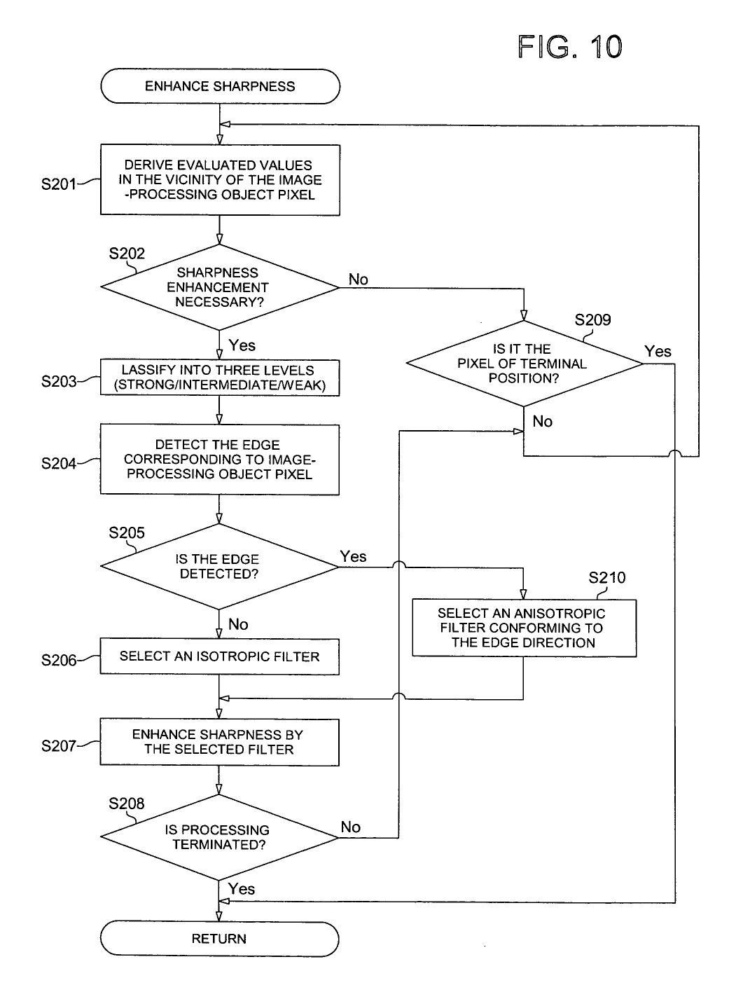

The image processing section 1 in the second embodiment detects the edge contained in of the predetermined area in the vicinity of the image-processing object pixel. Based on the information of the detected edge, the image processing section 1 determines (or selects) the characteristics (isotropism or anisotropy) of the spatial filter used in sharpness-enhancement processing. Using the spatial filter having the selected characteristics, the image processing section 1 applies sharpness-enhancement processing to the image-processing object pixel (FIG. 10).

<Filter Characteristics>

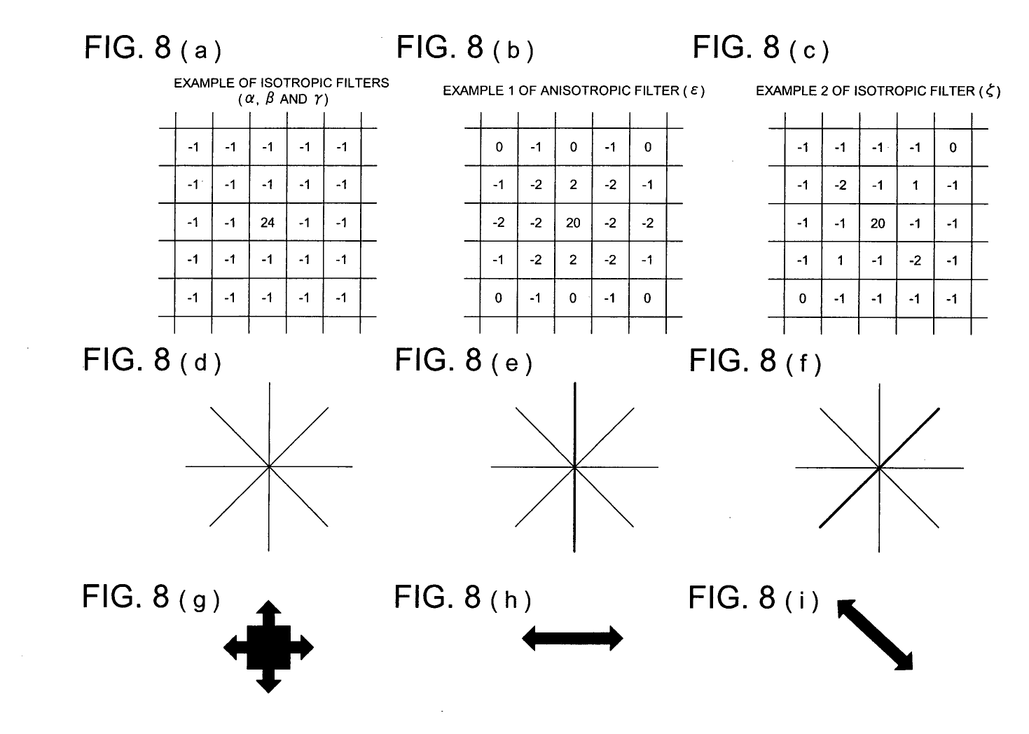

The following describes the characteristics of the spatial filter used for sharpness-enhancement processing as a second embodiment: FIGS. 8(a)-8(i) show examples of the spatial filters used in the second embodiment.

FIG. 8(a) shows the filters where f1=24 and f2 through f6=−1 in FIG. 2(b). They are the spatial filters α, β and γ used in the aforementioned first embodiment. The spatial filters α, β and γ shown in FIG. 8(a) have the same filter coefficient in each direction, so they act uniformly (isotropically) in each direction about the image-processing object pixel. The spatial filter ε shown in FIG. 8(b) and spatial filter ζ shown in FIG. 8(c) may have different filter coefficients, depending on the direction. To put it another way, they have anisotropy where the effect of enhancement is different depending on the direction.

The conceptual drawings representing the effect of enhancement by each spatial filter are given in FIG. 8(d) through FIG. 8(f). In FIG. 8(d) through FIG. 8(f), the size of each line represents the magnitude of the enhancement effect. For example, the spatial filters α, β and γ exhibit the enhancement effect uniform in all directions, as shown in FIG. 8(d). In the meantime, the spatial filter ε particularly enhances the edge extending in the vertical direction of the image-processing object pixel as shown in FIG. 8(e). The spatial filter ε particularly enhances the edge extending in a slanting direction of the image-processing object pixel. Since spatial filters ζ and $z are capable of enhancing in one direction, these spatial filters can be used to enhance the edge in the image. The characteristics (isotropism or anisotropy) of the spatial filters α, ε and ζ are shown by the pattern shown in FIG. 8(g), FIG. 8(h) and FIG. 8(i). The arrow-marked direction in FIG. 8(h) and FIG. 8(i) intersects the edge direction at right angles.

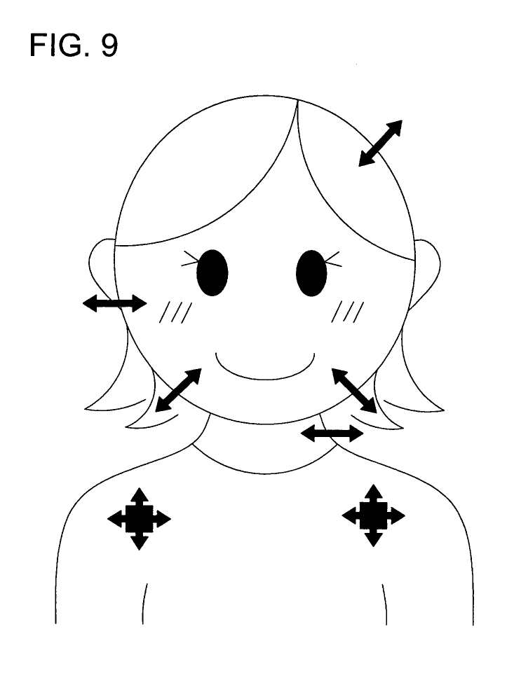

Referring to the portrait image shown in FIG. 9, an exampling of using the spatial filter will be described. FIG. 9 shows the filter used in response to each area of the image. In FIG. 9, an anisotropic spatial filter for edge enhancement is used in the direction orthogonal to the edge having a definite directionality such as that of the face profile or hair; whereas an isotropic spatial filter is used the area containing the edge devoid of clear directionality such as the shirt. Further, arrangement is made to ensure that the spatial filter does not act on locally flat portion such as the cheek.

In the second embodiment, similarly to the first embodiment, the strength of the spatial filter can be determined in conformity to the peripheral evaluation of the image-processing object pixel. As shown in FIGS. 4(c) and 5 (c), “strong filter”, “intermediate filter” and “weak filter” are set in conformity to the value of Cdiv. For example, of the spatial filters ε having the filter coefficient shown in FIG. 8(b), the filter with the Cdiv of 20 can be determined as a “weak filter”, the filter with the Cdiv of 1 as an “intermediate filter”, and the filter with the Cdiv of 5 as a “strong filter”.

The following describes the operations in the second embodiment: The flow of the entire image processing in the second embodiment is the same as that of the flowchart given in FIG. 6, and will not be described. Sharpness-enhancement processing in the second embodiment will be described with reference to the flowchart of FIG. 10. In the following flowchart, reference will be made of the case where the filter strength is determined according the filter selection method <1> shown in FIGS. 4(a)-4(c) in the first embodiment. The filter selection method <2> shown in FIGS. 5(a)-5(c) can also be used to perform the same processing as that given in FIG. 10.

As shown in the filter selection method <1> of FIGS. 4(a)-4(c), Ia or Ib in the vicinity of the image-processing object pixel is calculated. The peripheral evaluation values (A, B, C and D) are derived based on the calculated Ia or Ib (Step S201). Based on the evaluation value derived in Step S201, a decision is made to see whether or not sharpness-enhancement processing must be applied to image-processing object pixel (Step S202).

In Step S202, when the peripheral evaluation value is “A”, a decision is made that sharpness-enhancement processing is not required (NO in Step S202). Evaluation is made to determine whether or not the pixel as an object of processing at present is the last one (pixel of the terminal portion) in terms of the order of processing (Step S209).

In Step S209, if a decision is made that the image-processing object pixel is the final one (YES in Step S209), the sharpness-enhancement processing exits. In Step S209, if a decision is made that the image-processing object pixel is not the final one (NO in Step S209), the system goes back to Step S201, and a peripheral evaluation value is derived for the next pixel as an object for image-processing.

In Step S202, if the peripheral evaluation value is any one of B, C and D, a decision is made that sharpness-enhancement processing is necessary (YES in Step S202), and the type of the spatial filter (strong, intermediate or weak) used for sharpness-enhancement processing is determined in conformity to the evaluation value (Step S203).

The system starts to detect an edge in the vicinity of the image-processing object pixel (Step S204), and evaluation is made to determine whether the edge has been detected or not (Step S205). Various existing methods can be used for edge detection. Let us assume, for example, that the size of the area calculated by the spatial filter is 5 by 5 pixels. Anisotropic filters having a greater size (e.g. a 9 by 9-pixel filter) are prepared for various directions. Computation by the filters prepared for various directions is implemented for the image-processing object pixel. The direction compatible with the filter having the greatest enhancement effect can be determined as a direction for the edge.

In Step S205, when the edge is not detected (NO in Step S205), an isotropic filter is selected as a spatial filter to be used Step S206. Sharpness-enhancement processing is carried out by the isotropic filter having the strength determined in the Step S203 is applied to the relevant image-processing object pixel (Step S207).

In Step S205, when the edge corresponding to the image-processing object pixel has been detected (YES: Step S205), an anisotropic filter conforming to the direction of the detected edge is selected as a spatial filter to be used (Step S210). Sharpness-enhancement processing is applied to the image-processing object pixel by the filter having both the strength determined in Step S203 and the anisotropy selected in Step S210 (Step S207).

Upon completion of sharpness-enhancement processing, evaluation is made to determine whether or not the pixel to which sharpness-enhancement processing has been applied is the last one in terms of the order of processing, namely whether or not sharpness-enhancement processing has been completed (Step S208). In Step S208, if a decision is made that sharpness-enhancement processing is not yet completed (NO in Step S208), the system goes to Step S201, and a peripheral evaluation value is derived for the next pixel as an object for image-processing. In Step S208, if a decision is made that the sharpness-enhancement processing is completed (YES in Step S208), the sharpness-enhancement processing exits.

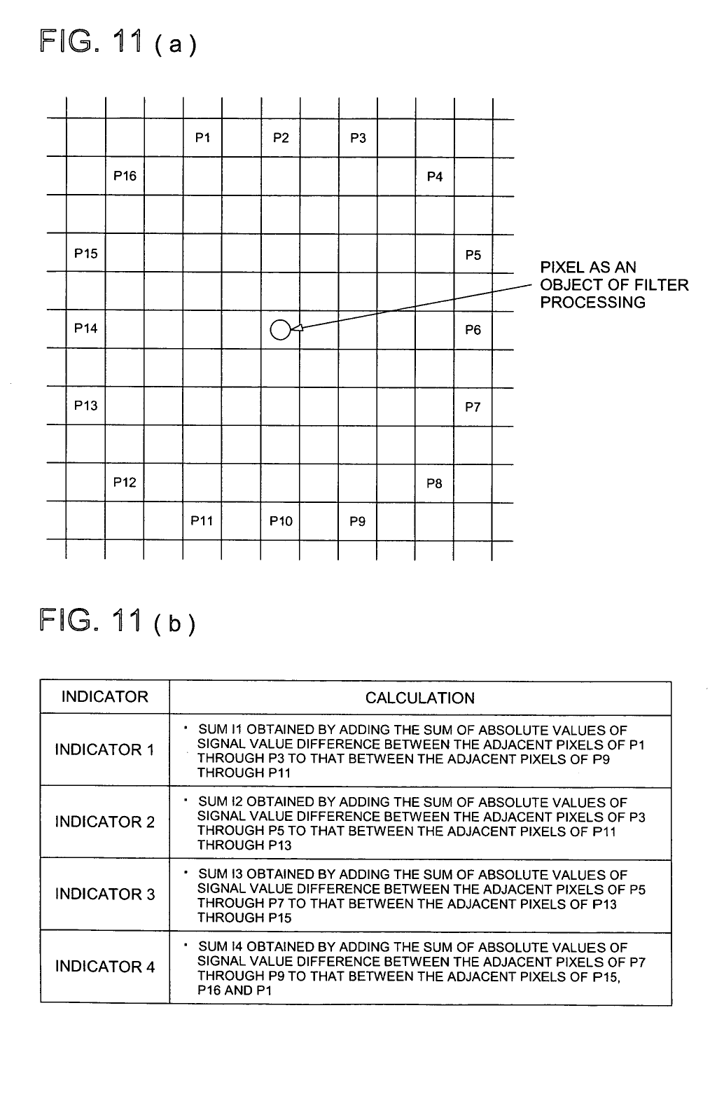

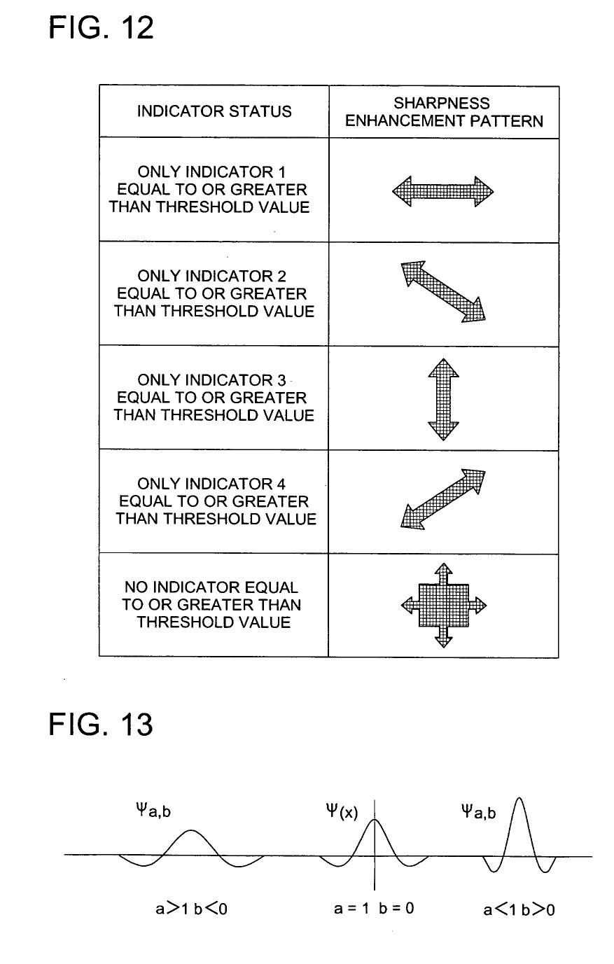

The method for selecting the filter characteristics (isotropism or anisotropy) by detecting the edge in the vicinity of the image-processing object pixel is not restricted to the aforementioned method. Another example of filter selection method will be described with reference to FIGS. 11(a)-11(b) and FIG. 12.

As shown in FIG. 11(a), it is assumed that sixteen pixels residing at positions equidistant from the image-processing object pixel by filter processing are sampling points, and the signal values of these sampling points are P1 through P16. Further, as shown in FIG. 11(b), four indicators (indicators 1 through 4) are provided to select the filter characteristics.

As shown in FIG. 11(b), calculation of the indicator 1 is made to get the sum I1, which is obtained by adding the sum of absolute values of the signal value difference between the adjacent pixels of P1 through P3 to that between the adjacent pixels of P9 through P11. Calculation of the indicator 2 is made to get the sum I2, which is obtained by adding the sum of absolute values of the signal value difference between the adjacent pixels of P3 through P5 to that between the adjacent pixels of P11 through P13. Calculation of the indicator 3 is made to get the sum I3, which is obtained by adding the sum of absolute values of the signal value difference between the adjacent pixels of P5 through P7 to that between the adjacent pixels of P13 through P15. Calculation of the indicator 4 is made to get the sum I4, which is obtained by adding the sum of absolute values of the signal value difference between the adjacent pixels of P7 through P9 to that between the adjacent pixels of P15, P16 and P1.

[Mathematical Formula 5]

Indicator 1:

I1=|P1−P2|+|P2−P3|+|P9−P10|+|P10−P11| (11)

Indicator 2:

I2=|P3−P4|+|P4−P5+P11−P12|+|P12−P13| (12)

Indicator 3:

I3=|P5−P6|+|P6−P7+|P13−P14|+|P14−P1| (13)

Indicator 4:

I4=|P7−P8|+P8−P9|+|P15−P16|+|P16−P1| (14)

The characteristics (isotropy and anisotropy) of the filter used for sharpness-enhancement processing are selected in response to the values of indicators 1 through 4. FIG. 12 shows the relationship between the status of the indicator and the pattern (FIG. 8(g), FIG. 8(h) and FIG. 8(i)) representing the filter pattern. When, of indicators 1 through 4, indicator 1 alone is equal to or greater than the predetermined threshold value, the anisotropic filter for enhancing in the vertical direction is utilized. When, of indicators 1 through 4, indicator 2 alone is equal to or greater than the predetermined threshold value, the anisotropic filter for enhancing in a slanting direction (an upward slope to the right) is utilized. When, of indicators 1 through 4, indicator 3 alone is equal to or greater than the predetermined threshold value, the anisotropic filter for enhancing in a horizontal direction is utilized. When, of indicators 1 through 4, indicator 4 alone is equal to or greater than the predetermined threshold value, the anisotropic filter for enhancing in a slanting direction (a downward slope to the right) is utilized. When there is no indicator that is equal to or greater than the predetermined threshold value, an isotropic filter is utilized. An alternative way of selection, for example, is to extract the greatest of indicators 1 through 4 (the maximum indicator) and to get the average value of the remaining three indicators. The value gained by dividing the maximum indicator by the average value can be used as an indicator for directionality. In this case, there is no directionality if the indicator for directionality is smaller than the predetermined threshold value, therefore an isotropic filter is used. If the indicator for directionality is greater than the predetermined threshold value, an anisotropic filter enhancing the direction corresponding to the maximum indicator is utilized.

FIG. 12 shows the case where the indicators 1 through 4 shown in FIG. 11(b) is used for edge detection. These indicators can be used to determine the filter strength, similarly to the first embodiment. In this manner, the same indicator can be used to determine the filter strength and to detect the edge, with the result that effective implementation of image processing can be ensured.

As described above, the image processing section in the second embodiment detects the edge on the periphery of the image-processing object pixel and uses the spatial filter suited for edge direction to perform sharpness-enhancement processing. This arrangement provides a sharpness-enhancement processing effect characterized by preferable linear reproducibility in conformity to each area of the image.

If there is an edge, an anisotropic filter is used to apply sharpness-enhancement processing. This allows sharpness to be enhanced in the direction orthogonal to the edge, with the result that powerful representation of the linear structure in the image is provided. Further, the sharpness enhancement in the direction of edge flow is weakened, or sharpness is reduced, namely, smoothness is achieved, depending on the method of setting the filter coefficient, for example, if the filter coefficient is 20 through 8 and that of the lower and higher filters is 2 through 8 in FIG. 8(b), with the result that the granularity in the direction of edge flow is suppressed and smooth image representation is ensured.

When an edge is present, the direction of sharpness enhancement is specified, the filter coefficient required for edge enhancement can be set generally to a smaller level than that of the case where an isotropic filter is used. This arrangement ensures that the granularity in the direction of edge flow is suppressed and smooth image representation is provided.

As shown in FIG. 11(a) and FIG. 11(b), in particular, a plurality of pixels located equidistant from the image-processing object pixel are assumed as sampling points, and the edge is detected by the change in signal values in each direction of the sampling points, whereby edge detection is ensured by simple calculation.

The method of evaluating the edge direction in the image (edge detection method) is not restricted to the aforementioned method. For example, multi-resolution conversion processing can be used to evaluate the edge direction in analytical terms can be used.

The following describes the multi-resolution conversion processing:

[Multiple Resolution Conversion]

Further, the “multiple resolution conversion” is a generic name of the methods represented by the wavelet conversion, the full-restructuring filter bank, the Laplacian pyramid, etc. In this method, one converting operation allows the inputted signals to be decomposed into high-frequency component signals and low-frequency component signals, and then, a same kind of converting operation is further applied to the acquired low-frequency component signals, in order to obtain the multiple resolution signals including a plurality of signals locating in frequency bands being different relative to each other. The multiple resolution signals can be restructured to the original signals by applying the multiple resolution inverse-conversion to the multiple resolution signals as it is without adding any modification to them. The detailed explanations of such the methods are set forth in, for instance, “Wavelet and Filter banks” by G. Strang & T. Nguyen, Wellesley-Cambridge Press.

As a representative example of the multi-resolution conversion, the Dyadic Wavelet transform will be summarized in the following. The wavelet transform is operated as follows: In the first place, the following wavelet function shown in equation (15), where vibration is observed in a finite range as shown in FIG. 1, is used to obtain the wavelet transform coefficient <f, ψ_{a, b}> with respect to input signal f(x) by employing equation (16). Through this process, input signal is converted into the sum total of the wavelet function shown in equation (17).

$$\begin{matrix}{ψ}_{a , b} ( x ) = ψ ( \frac{x - b}{a} ) & ( 15 ) \\ ⟨ f , {ψ}_{a , b} ⟩ ≡ \frac{1}{a} \int f ( x ) \cdot ψ ( \frac{x - b}{a} ) ⅆ x & ( 16 ) \\ f ( x ) = {\sum }_{a , b} ⟨ f , {ψ}_{a , b} ⟩ \cdot {ψ}_{a , b} ( x ) & ( 17 )\end{matrix}$$

In the above equations (15)-(17), “a” denotes the scale of the wavelet function, and “b” the position of the wavelet function. As shown in FIG. 1, as the value “a” is greater, the frequency of the wavelet function ψ_{a, b}(x) is smaller. The position where the wavelet function ψ_{a, b}(x) vibrates moves according to the value of position “b”. Thus, equation (17) signifies that the input signal f(x) is decomposed into the sum total of the wavelet function ψ_{a, b}(x) having various scales and positions.

Among such the wavelet transforms, the orthogonal wavelet conversion and the bi-orthogonal wavelet conversion have been specifically well known as the “multi-resolution conversion method, which reduces the image size”, described in the present invention. The orthogonal wavelet conversion and the bi-orthogonal wavelet conversion will be summarized in the following.

The wavelet function in the orthogonal wavelet conversion and the bi-orthogonal wavelet conversion is defined by equation (18) shown in the following.

$${ψ}_{i , j} ( x ) = {2}^{- i} ψ ( \frac{x - j \cdot {2}^{i}}{{2}^{i}} ) \qquad ( 18 )$$

where “i” denotes a natural number.

Comparison between equation (18) and equation (15) shows that the value of scale “a” is defined discretely by an i-th power of “2”, in the orthogonal wavelet conversion and the bi-orthogonal wavelet conversion. This value “i” is called a level.

In practical terms, level “i” is restricted up to finite upper limit N, and input signal f(x) is expressed as shown in equation (19), equation (20) and equation (21).

$$\begin{matrix}f ( x ) ≡ {S}_{0} = {\sum }_{j} ⟨ {S}_{0} , {ψ}_{1 , j} ⟩ \cdot {ψ}_{1 , j} ( x ) + {\sum }_{j} ⟨ {S}_{0} , {φ}_{1 , j} ⟩ \cdot {φ}_{1 , j} ( x ) \\ ≡ {\sum }_{j} {W}_{1} ( j ) \cdot {ψ}_{1 , j} ( x ) + {\sum }_{j} {S}_{1} ( j ) \cdot {φ}_{1 , j} ( x ) & ( 19 ) \\ {S}_{i - 1} = {\sum }_{j} ⟨ {S}_{i - 1} , {ψ}_{i , j} ⟩ \cdot {ψ}_{i , j} ( x ) + {\sum }_{j} ⟨ {S}_{i - 1} , {φ}_{i , j} ⟩ \cdot {φ}_{i , j} ( x ) \\ ≡ {\sum }_{j} {W}_{i} ( j ) \cdot {ψ}_{i , j} ( x ) + {\sum }_{j} {S}_{i} ( j ) \cdot {φ}_{i , j} ( x ) & ( 20 ) \\ f ( x ) ≡ {S}_{0} = {\sum }_{i = 1}^{N} {\sum }_{j} {W}_{i} ( j ) \cdot {ψ}_{1 , j} ( x ) + {\sum }_{j} {S}_{N} ( j ) \cdot {φ}_{1 , j} ( x ) & ( 21 )\end{matrix}$$

The second term of equation (19) denotes that the low frequency band component of the residue that cannot be represented by the sum total of wavelet function ψ_{1, j}(x) of level 1 is represented in terms of the sum total of scaling function φ_{1, j}(x). An adequate scaling function in response to the wavelet function is employed (refer to the aforementioned reference). This means that input signal f(x)≡S₀ is decomposed into the high frequency band component W₁ and low frequency band component Sᵢ of level 1 by the wavelet transform of level 1 shown in equation (19).

Since the minimum traveling unit of the wavelet function ψ_{i, j}(x) is 2ⁱ, each of the signal volume of high frequency band component W₁ and low frequency band component S₁ with respect to the signal volume of input signal ‘S₀’ is ½. The sum total of the signal volumes of high frequency band component W₁ and low frequency band component S₁ is equal to the signal volume of input signal “S₀”. The low frequency band component S₁, obtained by the wavelet transform of level 1, is decomposed into high frequency band component W₂ and low frequency band component S₂ of level 2 by equation (20). After that, transform is repeated up to level N, whereby input signal “S₀” is decomposed into the sum total of the high frequency band components of levels 1 through N and the sum of the low frequency band components of level N, as shown in equation (21).

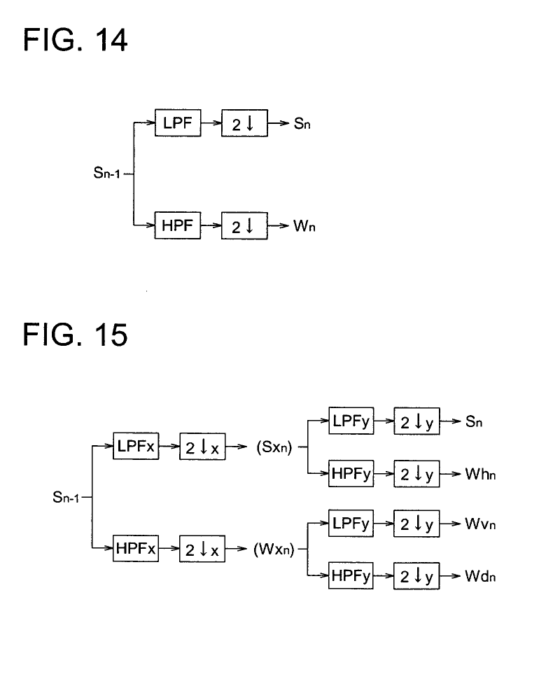

Incidentally, it has been well known that the wavelet transform of level 1, shown in equation (20), can be computed by the filtering process, which employs low-pass filter LPF and high-pass filter HPF as shown in FIG. 14. In FIG. 14, LPF denotes a low-pass filter, while HPF denotes a high-pass filter. The filter coefficients of low-pass filter LPF and high-pass filter HPF are appropriately determined corresponding to the wavelet function (refer to the aforementioned reference document). In FIG. 14, symbol 21 shows the down sampling where every other samples are removed.

As shown in FIG. 14, input signal “Sₙ₋₁” can be decomposed into the high frequency band component Wₙ and the low frequency band component Sₙ, by processing input signal “Sₙ₋₁” with low-pass filter LPF and high-pass filter HPF, and by thinning out signals at every other samples.

The wavelet transform of level 1 for the two-dimensional signals, such as the image signals, is conducted in the filtering process as shown in FIG. 15. In FIG. 15, the suffix “x”, subscripted as LPFₓ, HPFₓ and 2↓ₓ, indicates the processing in the direction of “x”, while the suffix “y”, subscripted as LPF_{y}, HPF_{y} and 2↓_{y}, indicates the processing in the direction of “y”. Initially, the filter processing is applied to input signal Sₙ₋₁ by means of low-pass filter LPFₓ and high-pass filter HPFₓ in the direction of “x”, and then, the down sampling is conducted in the direction of “x”. By conducting such the processing, input signal Sₙ₋₁ is decomposed into low frequency band component SXₙ and high frequency band component WXₙ. Further, the filter processing is applied to low frequency band component SXₙ and high frequency band component WXₙ by means of low-pass filter LPF_{y} and high-pass filter HPF_{y} in the direction of “y”, and then, the down sampling is conducted in the direction of “y”.

According to the wavelet transform of level 1, input signal Sₙ₋₁ can be decomposed into three high frequency band components Wvₙ, Whₙ, Wdₙ and one low frequency band component Sₙ. Since each of the signal volumes of Wvₙ, Whₙ, Wdₙ and Sₙ, generated by a single wavelet transform operation, is ½ of that of the input signal Sₙ₋₁ prior to decomposition in both vertical and horizontal directions, the total sum of signal volumes of four components subsequent to decomposition is equal to the signal Sₙ₋₁ prior to decomposition.

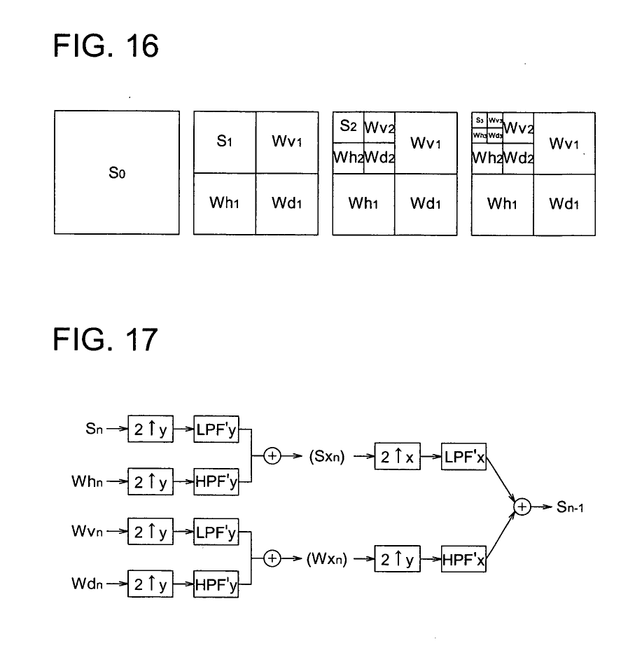

FIG. 16 shows the type process of decomposing input signal “S₀” by means of the wavelet transform of level 1, level 2 and level 3. As the level number “i” increases, the image signal is further thinned out by the down sampling operation, and the decomposed image is getting small.

Further, it has been well known that, by applying the wavelet inverse transform, which would be calculated in the filtering process, or the like, to Wvₙ, Whₙ, Wdₙ and Sₙ generated by decomposition processing, the signal Sₙ₋₁ prior to decomposition can be fully reconstructed as shown in FIG. 17. Incidentally, in FIG. 17, LPF′ indicates a low-pass filter for inverse transform, while HPF′ indicates a high-pass filter for inverse transform. Further, 2↑ denotes the up-sampling where zero is inserted into every other signals. Still further, the suffix “x”, subscripted as LPF′ₓ, HPF′ₓ and 2↑ₓ, indicates the processing in the direction of “x”, while the suffix “y”, subscripted as LPF′_{y}, HPF′_{y} and 2↑_{y}, indicates the processing in the direction of “y”.

As shown in FIG. 17, low frequency band component SXₙ can be obtained by adding a signal, which is acquired by up-sampling Sₙ in the direction of “y” and processing with low-pass filter LPF′y in the direction of “y”, and another signal, which is acquired by up-sampling Whₙ in the direction of “y” and processing with high-pass filter HPF′y in the direction of “y”, to each other. As well as the above process, WXₙ is generated from Wvₙ and Wdₙ.

Further, the signal Sₙ₋₁ prior to decomposition can be reconstructed by adding a signal, which is acquired by up-sampling SXₙ in the direction of “x” and processing with low-pass filter LPF′ₓ in the direction of “x”, and another signal, which is acquired by up-sampling WXₙ in the direction of “x” and processing with high-pass filter HPF′ₓ in the direction of “x”, to each other.

In case of the orthogonal wavelet conversion, the coefficient of the filter employed for the inverse transforming operation is the same as that of the filter employed for the transforming operation. On the other hand, in case of the bi-orthogonal wavelet conversion, the coefficient of the filter employed for the inverse transforming operation is different from that of the filter employed for the transforming operation (refer to the aforementioned reference document).

The detailed explanations for the Dyadic Wavelet transform employed in the present invention are set forth in the aforementioned non-Patent Document, “Characterization of signal from multiscale edges” by S. Mallet and S. Zhong, IEEE Trans. Pattern Anal. Machine Intel. 14 710 (1992), and “A wavelet tour of signal processing 2ed.” by S. Mallat, Academic Press. The Dyadic Wavelet transform will be summarized in the following.

The wavelet function employed in the Dyadic Wavelet transform is defined by equation (8) shown below.

$${ψ}_{i , j} ( x ) = {2}^{- i} ψ ( \frac{x - j}{{2}^{i}} ) \qquad ( 8 )$$

where “i” denotes a natural number.

As aforementioned, the Wavelet functions of the orthogonal wavelet transform and the bi-orthogonal wavelet transform are discretely defined when the minimum traveling unit of the position on level “i” is 2ⁱ, as described above. By contrast, in the Dyadic Wavelet transform, the minimum traveling unit of the position is kept constant, regardless of level “i”. This difference brings the following characteristics to the Dyadic Wavelet transform.

Characteristic 1: The signal volume of each of high frequency band component Wᵢ and low frequency band component Sᵢ generated by the Dyadic Wavelet transform of level 1 shown by equation (23) is the same as that of signal Sᵢ₋₁ prior to transform.

$${S}_{i - 1} = {\sum }_{j} ⟨ {S}_{i - 1} , {ψ}_{i , j} ⟩ \cdot {ψ}_{i , j} ( x ) + {\sum }_{j} ⟨ {S}_{i - 1} , {φ}_{i , j} ⟩ \cdot {φ}_{i , j} ( x ) \\ ≡ {\sum }_{j} {W}_{i} ( j ) \cdot {ψ}_{i , j} ( x ) + {\sum }_{j} {S}_{i} ( j ) \cdot {φ}_{i , j} ( x ) \qquad ( 23 )$$

Accordingly, unlike the orthogonal wavelet transform and the bi-orthogonal wavelet transform, the image size after applying the Dyadic Wavelet transform is not reduced, compared to the original image size.

Characteristic 2: The scaling function φ_{i, j}(x) and the wavelet function ψ_{i, j}(x) fulfill the following relationship shown by equation (24).

$${ψ}_{i , j} ( x ) = \frac{\partial }{\partial x} {φ}_{i , j} ( x ) \qquad ( 24 )$$

Thus, the high frequency band component Wᵢ generated by the Dyadic Wavelet transform of level 1 represents the first differential (gradient) of the low frequency band component Sᵢ.

Characteristic 3: With respect to Wᵢ·γᵢ (hereinafter referred to as “compensated high frequency band component) obtained by multiplying the coefficient γᵢ (refer to the aforementioned reference documents in regard to the Dyadic Wavelet transform) determined in response to the level “i” of the Wavelet transform, by high frequency band component, the relationship between levels of the signal intensities of compensated high frequency band components Wᵢ·γᵢ subsequent to the above-mentioned transform obeys a certain rule, in response to the singularity of the changes of input signals, as described in the following.

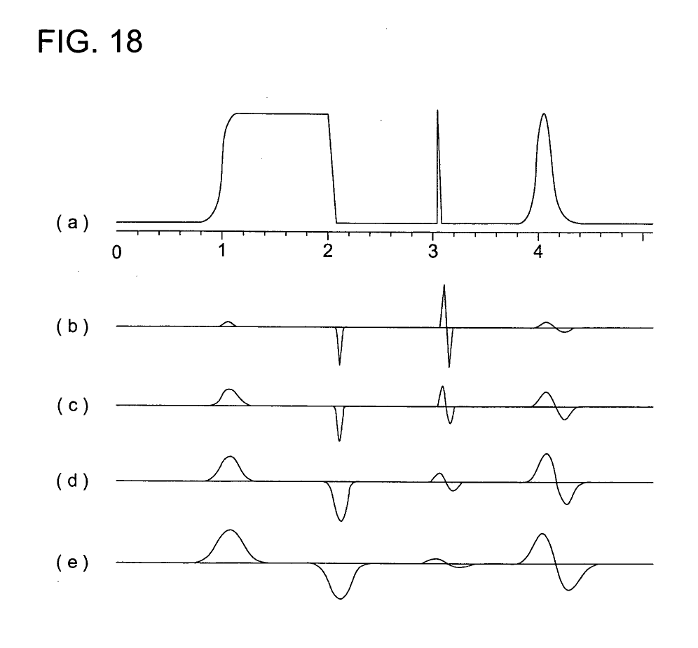

FIG. 18 shows exemplified waveforms of input signal “S₀” and compensated high frequency band components acquired by the Dyadic Wavelet transform of every level.

Namely, FIG. 18 shows exemplified waveforms of: input signal “S₀” at line (a); compensated high frequency band component W₁·γ₁, acquired by the Dyadic Wavelet transform of level 1, at line (b); compensated high frequency band component W₂·γ₂, acquired by the Dyadic Wavelet transform of level 2, at line (c); compensated high frequency band component W₃·γ₃, acquired by the Dyadic Wavelet transform of level 3, at line (d); and compensated high frequency band component W₄·γ₄, acquired by the Dyadic Wavelet transform of level 4, at line (e).

Observing the changes of the signal intensities step by step, the signal intensity of the compensated high frequency band component Wᵢ γᵢ, corresponding to a gradual change of the signal intensity shown at “1” and “4” of line (a), increases according as the level number “i” increases, as shown in line (b) through line (e).

With respect to input signal “S₀”, the signal intensity of the compensated high frequency band component Wᵢ·γᵢ, corresponding to a stepwise signal change shown at “2” of line (a), is kept constant irrespective of the level number “i”. Further, with respect to input signal “S₀”, the signal intensity of the compensated high frequency band component Wᵢ·γᵢ, corresponding to a signal change of δ-function shown at “3” of line (a), decreases according as the level number “i” increases, as shown in line (b) through line (e).

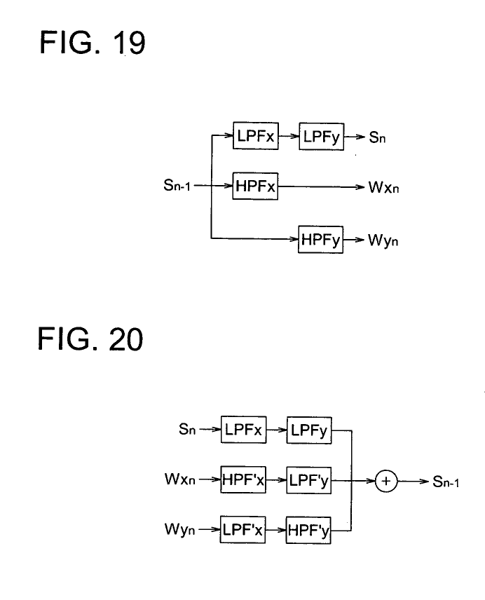

Characteristic 4: Unlike the above-mentioned method of the orthogonal wavelet transform and the bi-orthogonal wavelet transform, the method of Dyadic Wavelet transform of level 1 in respect to the two-dimensional signals such as the image signals is followed as shown in FIG. 19.

As shown in FIG. 19, in the Dyadic Wavelet transform of level 1, low frequency band component Sₙ can be acquired by processing input signal Sₙ₋₁ with low-pass filter LPFₓ in the direction of “x” and low-pass filter LPF_{y} in the direction of “y”. Further, a high frequency band component Wxₙ can be acquired by processing input signal Sₙ₋₁ with high-pass filter HPFₓ in the direction of “x”, while another high frequency band component Wyₙ can be acquired by processing input signal Sₙ₋₁ with high-pass filter HPF_{y} in the direction of “y”.

The low frequency band component Sₙ₋₁ is decomposed into two high frequency band components Wxₙ, Wyₙ and one low frequency band component Sₙ by the Dyadic Wavelet transform of level 1. Two high frequency band components correspond to components x and y of the change vector Vₙ in the two dimensions of the low frequency band component Sₙ. The magnitude Mₙ of the change vector Vₙ and angle of deflection Aₙ are given by equation (25) and equation (26) shown as follow.

Mₙ=\sqrt{Wxₙ²+Wyₙ²} (25)

Aₙ=argument (Wxₙ+iWyₙ) (26)

Sₙ₋₁ prior to transform can be reconfigured when the Dyadic Wavelet inverse transform shown in FIG. 20 is applied to two high frequency band components Wxₙ, Wyₙ and one low frequency band component Sn. In other words, input signal Sₙ₋₁ prior to transform can be reconstructed by adding the signals of: the signal acquired by processing low frequency band component Sₙ with low-pass filters LPFₓ and LPF_{y}, both used for the forward transform in the directions of “x” and “y”; the signal acquired by processing high frequency band component WXₙ with high-pass filter HPF′ₓ in the direction of “x” and low-pass filter LPF′_{y} in the direction of “y”; and the signal acquired by processing high frequency band component Wyₙ with low-pass filter LPF′ₓ in the direction of “x” and high-pass filter HPF′_{y} in the direction of “y”; together.

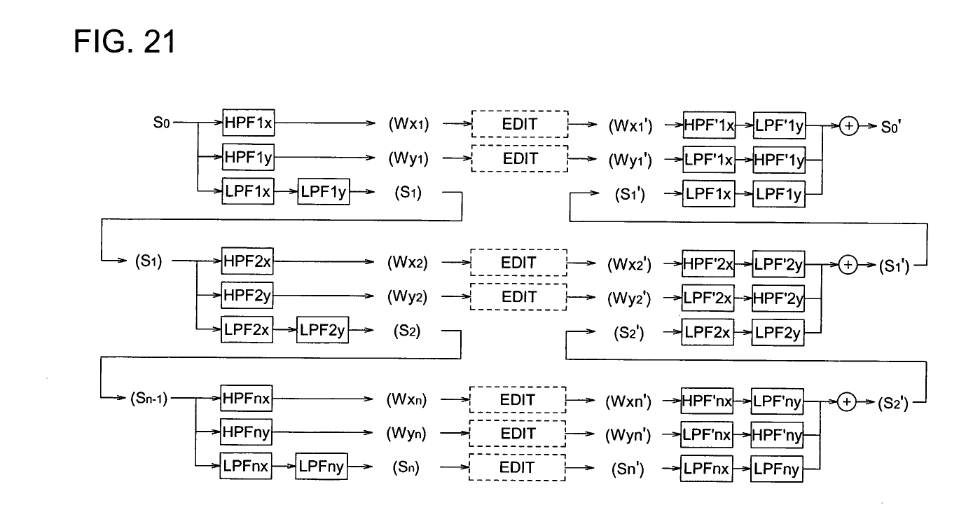

Next, referring to FIG. 21, the method for acquiring output signals S₀′, having the steps of applying the Dyadic Wavelet transform of level “n” to input signals “S₀”, applying a certain kind of image-processing (referred to as “editing” in FIG. 21) to the acquired high frequency band components and the acquired low frequency band component, and then, conducting the Dyadic Wavelet inverse-transform to acquire output signals S₀′, will be detailed in the following.

In the Dyadic Wavelet transform of level 1 for input signal “S₀”, input signal “S₀” is decomposed into two high frequency band components Wx₁, Wy₁ and low frequency band component S₁. In the Dyadic Wavelet transform of level 2, low frequency band component S₁ is further decomposed into two high frequency band components Wx₂, Wy₂ and low frequency band component S₂. By repeating the above-mentioned operational processing up to level “n”, input signal “S₀” is decomposed into a plurality of high frequency band components Wx₁, Wx₂, - - - Wxₙ, Wy₁, Wy₂, - - - Wyₙ and a single low frequency band component Sₙ.

The image-processing (the editing operations) are applied to high frequency band components Wx₁, Wx₂, - - - Wxₙ, Wy₁, Wy₂, - - - Wyₙ and low frequency band component Sₙ generated through the abovementioned processes to acquire edited high frequency band components Wx₁′, Wx₂′, - - - Wxₙ′, Wy₁′, Wy₂′, - - - Wyₙ′ and edited low frequency band component Sₙ′.

Then, the Dyadic Wavelet inverse-transform is applied to edited high frequency band components Wx₁′, Wx₂′, - - - Wxₙ′, Wy₁′, Wy₂′, - - - Wyₙ′ and edited low frequency band component Sₙ′. Specifically speaking, the edited low frequency band component Sₙ₋₁′ of level (n-1) is restructured from the two edited high frequency band components Wxₙ′, Wyₙ′ of level “n” and the edited low frequency band component Sₙ′ of level N. By repeating this operation shown in FIG. 21, the edited low frequency band component S₁′ of level 1 is restructured from the two edited high frequency band components Wx₂′, Wy₂′ of level 2 and the edited low frequency band component S₂′ of level 2. Successively, the edited low frequency band component S₀′ is restructured from the two edited high frequency band components Wx₁′, Wy₁′ of level 1 and the edited low frequency band component S₁′ of level 1.

The filter coefficients of the filters, employed for the operations shown in FIG. 21, are appropriately determined corresponding to the wavelet functions. Further, in the Dyadic Wavelet transform, the filter coefficients, employed for every level number, are different relative to each other. The filtering coefficients employed for level “n” are created by inserting 2ⁿ⁻¹-1 zeros into each interval between filtering coefficients for level 1. The abovementioned procedure is set forth in the aforementioned reference document.

Further, although only an example of applying the image processing (the editing operation) to the high frequency band components and the low frequency band component, which are finally acquired through the process of the Dyadic Wavelet transform, is shown in FIG. 21, it is also applicable that the image processing (the editing operation) is applied to the synthesized image signals of the low frequency band component after applying the Dyadic Wavelet transform, as needed. Further, it is still applicable that the image processing (the editing operation) is applied to the image signals of the low frequency band component, which are in mid-course of the Dyadic Wavelet transform operation.

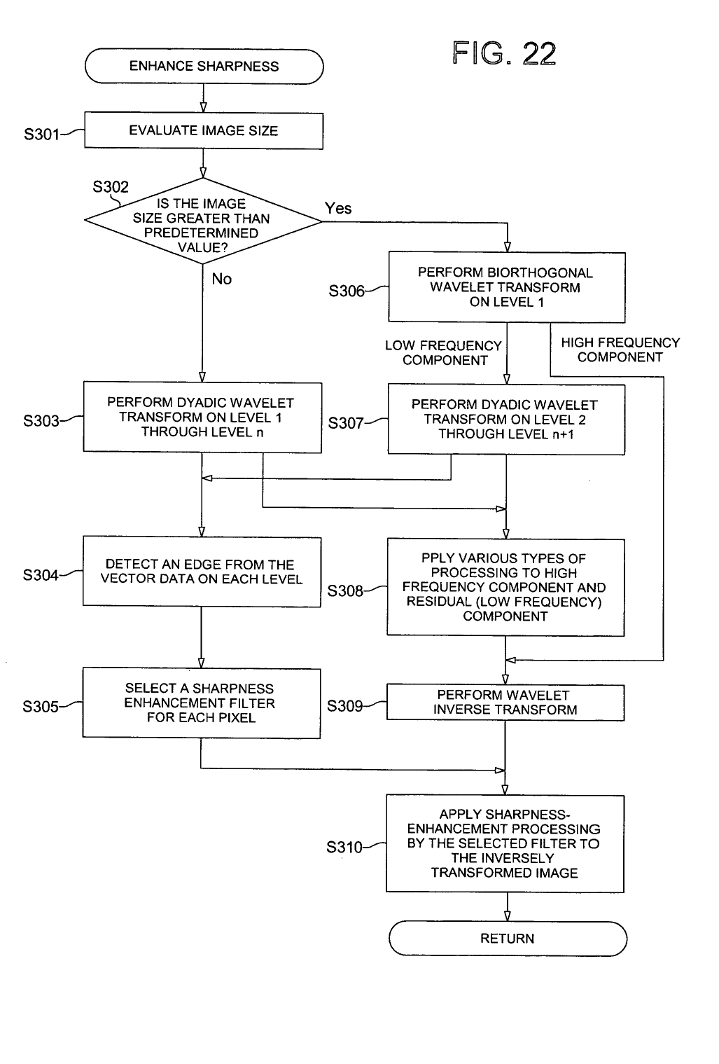

The following describes the sharpness-enhancement processing for edge detection using the wavelet transform, with reference to the flowchart of FIG. 22:

The size of the image as a sharpness-enhancement processing object pixel is evaluated (Step S301), and evaluation is made to determine whether or not the image size is greater than a previously set value (a predetermined value) (Step S302). When evaluating the image size, for example, when outputting the image to the printer, the image has a very large size, but to evaluate the image structure in this case, detailed structure is not required in many cases. This is intended to reduce the image processing time that might be wasted otherwise.

In Step S302, when the image size has been determined to be smaller than the predetermined value (NO in Step S302), dyadic wavelet transform is carried out after the image as an object to be processed (Step S303). Suppose that level “n” requires dyadic wavelet transform. In Step S303, dyadic wavelet transform is carried out in the order of level 1, level 2, level 3 . . . and level n. The vector data (formulas (25) and (26)) as edge information is acquired from the decomposed image generated by dyadic wavelet transform on each level in Step S303, and is stored.

An edge is detected from the vector data (formulas (25) and (26)) acquired on each level (Step S304). The formula (25) represents the strength of the edge, and the formula (26) represents the direction of the edge. From the edge information (strength and direction of the edge) acquired by edge detection in Step S304, the spatial filter applied to each pixel in the image is selected (determined) (Step S305). The method shown in FIGS. 8(a)-8(i) through FIG. 12 can be used to select the spatial filter based on the edge.

While edge detection and filter selection are performed, various forms of image (edit) processing are applied to the high-frequency component generated by dyadic wavelet transform on each level in Step S303 and the residual component (low-frequency components on level n) (Step S308). Then the image (decomposed image) edited on each level undergoes wavelet inverse transform (Step S309); thus, an image of the original size can be obtained.

Then sharpness-enhancement processing by the spatial filter selected in Step S305 is applied to the image having undergone wavelet inverse transform (Step S310), and sharpness-enhancement processing exits.

In Step S302, when the image size has been evaluated to be greater than the predetermined values (YES in Step S302), biorthogonal wavelet transform on level 1 is applied to the image as an object to be processed (Step S306). The biorthogonal wavelet transform is used when the image has an excessively large size. This is because the image size resulting from biorthogonal wavelet transform is reduced.

Then dyadic wavelet transform from level 2 to level n is applied to the low-frequency component generated by biorthogonal wavelet transform (Step S307). The level 2 and thereafter are switched over by dyadic wavelet transform because the dyadic wavelet transform provides higher precision information acquisition. The vector data (formulas (25) and (26)) as edge information is acquired from the decomposed image generated by dyadic wavelet transform on each level in Step S307, and is stored.

An edge is detected from the vector data (formulas (25) and (26)) acquired on each level (Step S304). The formula (25) represents the strength of the edge, and the formula (26) represents the direction of the edge. From the edge information (strength and direction of the edge) acquired by edge detection in Step S304, the spatial filter applied to each pixel in the image is selected (determined) (Step S305). The method shown in FIGS. 8(a)-8(c) through FIG. 12 can be used to select the spatial filter based on the edge.

While edge detection and filter selection are performed, various forms of image (edit) processing are applied to the high-frequency component generated by dyadic wavelet transform on each level in Step S307 and the residual component (low-frequency components on level n) (Step S308). Then the image (decomposed image) edited on each level and high frequency component generated by biorthogonal wavelet transform undergo wavelet inverse transform (Step S309); thus, an image of the original size can be obtained.

Then sharpness-enhancement processing by the spatial filter selected in Step S305 is applied to the image having undergone wavelet inverse transform (Step S310), and sharpness-enhancement processing exits.

As shown in FIG. 22, use of the dyadic wavelet transform permits easy acquisition of edge information. As will be apparent from the description of the aforementioned wavelet transform, the dyadic wavelet transform involves a considerable amount of calculations, and is not suited for use in edge detection alone. However, the information from the decomposed image generated by the dyadic wavelet transform can be used for various forms of advanced image processing.

For example, the edge structure and strength gained by dyadic wavelet transform can be evaluated and used for scene division, subject pattern extraction and other work. Further, identification of the major subject, recognition of the degree of importance and advanced dodging can be achieved by using the information obtained by dyadic wavelet transform. An image processing system equipped with such advanced image processing functions provides easy acquisition of edge information as sub-information.

The description of the aforementioned embodiment can be modified as required, without departing from the spirit of the present invention.

As described in the foregoing, according to the present invention, the following effects can be attained.

(1) It is possible to suppress enhancement of image noise tending to be conspicuous in the processing of image noise such as noise of an isolated point, by applying a sharpness-enhancement processing based on the conditions of pixels in the peripheral area without containing a processing object pixel, whereby an image with minimized noise can be provided.

(2) Easy derivation of image characteristic information as well as high performance image processing can be achieved.

(3) A spatial filter used for sharpness enhancement is selected in response to image characteristic information. This arrangement provides a preferable sharpness-enhancement effect conforming to each area in the image.

(4) A spatial filter used for sharpness enhancement can be used in response to image characteristic information. This arrangement provides a preferable sharpness-enhancement effect conforming to each area in the image.

(5) The decomposed image generated by multi-resolution conversion processing is used to derive the image characteristic information, thereby getting the image characteristic information with consideration given to the broader perspective of the image structure.

(6) A Dyadic Wavelet transform is employed in multi-resolution conversion processing, thereby providing higher-precision image characteristic information and hence ensuring higher-precision image processing.

(7) Image characteristic information can be obtained without complicated calculation and easy selection of a spatial filter is ensured, with the result that noiseless sharpness-enhancement effect is easily obtained.

Disclosed embodiment can be varied by a skilled person without departing from the spirit and scope of the invention.

What is claimed is:

1. A method for processing an input image, so as to output a processed image revised from said input image, comprising the steps of:
deriving image characteristic information of a predetermined area, which includes adjacent pixels and is located in a vicinity of an image-processing object pixel other than said adjacent pixels, from information of said adjacent pixels residing in said predetermined area, both said adjacent pixels and said image-processing object pixel being included in said input image; and
applying a sharpness-enhancement processing to said image-processing object pixel, based on said image characteristic information derived in said deriving step.

2. The method of claim 1,
wherein said image characteristic information includes at least one of a sum of differential signal absolute-values between said adjacent pixels residing in said predetermined area, a variance of each signal value of said adjacent pixels residing in said predetermined area and a standard deviation of each signal value of said adjacent pixels residing in said predetermined area.

3. The method of claim 1, further comprising the step of:
selecting a specific spatial filter out of a plurality of spatial filters, which are different relative to each other in terms of relationships between image-edge directions and edge-enhancing degrees, based on said image characteristic information derived in said deriving step;
wherein said specific spatial filter, selected in said selecting step, is employed for said sharpness-enhancement processing.

4. A method for processing an input image, so as to output a processed image revised from said input image, comprising the steps of:
deriving image characteristic information of a predetermined area, which includes adjacent pixels and is located in a vicinity of an image-processing object pixel other than said adjacent pixels, from information of said adjacent pixels residing in said predetermined area, both said adjacent pixels and said image-processing object pixel being included in said input image; and
selecting a specific spatial filter out of a plurality of spatial filters, which are different relative to each other in terms of relationships between image-edge directions and edge-enhancing degrees, based on said image characteristic information derived in said deriving step;
applying a sharpness-enhancement processing to said image-processing object pixel, by employing said specific spatial filter selected in said selecting step.

5. The method of claim 4,
wherein, in said deriving step, a multi-resolution conversion processing is applied to said input image so as to decompose said input image into a plurality of decomposed images, and then, said image characteristic information are derived from said plurality of decomposed images generated by said multi-resolution conversion processing.

6. The method of claim 5,
wherein, in said deriving step, a Dyadic Wavelet transform is employed in an image-decomposing process at a level higher than at least level 2 of said multi-resolution conversion processing, and then, edge information, serving as said image characteristic information with respect to edge portions included in said input image, are derived from said plurality of decomposed images generated by said Dyadic Wavelet transform.

7. The method of claim 4,
wherein, in said deriving step, information, representing a dispersion degree of signal values of plural pixels residing on positions being substantially equidistant from said image-processing object pixel in said predetermined area, are derived as said image characteristic information.

8. An apparatus for processing an input image, so as to output a processed image revised from said input image, comprising:
a deriving section to derive image characteristic information of a predetermined area, which includes adjacent pixels and is located in a vicinity of an image-processing object pixel other than said adjacent pixels, from information of said adjacent pixels residing in said predetermined area, both said adjacent pixels and said image-processing object pixel being included in said input image; and
an image-processing section to apply a sharpness-enhancement processing to said image-processing object pixel, based on said image characteristic information derived by said deriving section.

9. The apparatus of claim 8,
wherein said image characteristic information includes at least one of a sum of differential signal absolute-values between said adjacent pixels residing in said predetermined area, a variance of each signal value of said adjacent pixels residing in said predetermined area and a standard deviation of each signal value of said adjacent pixels residing in said predetermined area.

10. The apparatus of claim 8, further comprising:
a filter selecting section to select a specific spatial filter out of a plurality of spatial filters, which are different relative to each other in terms of relationships between image-edge directions and edge-enhancing degrees, based on said image characteristic information derived by said deriving section;
wherein said image-processing section employs said specific spatial filter, selected by said filter selecting section, for conducting said sharpness-enhancement processing.

11. An apparatus for processing an input image, so as to output a processed image revised from said input image, comprising:
a deriving section to derive image characteristic information of a predetermined area, which includes adjacent pixels and is located in a vicinity of an image-processing object pixel other than said adjacent pixels, from information of said adjacent pixels residing in said predetermined area, both said adjacent pixels and said image-processing object pixel being included in said input image; and
a filter selecting section to select a specific spatial filter out of a plurality of spatial filters, which are different relative to each other in terms of relationships between image-edge directions and edge-enhancing degrees, based on said image characteristic information derived by said deriving section;
an image-processing section to apply a sharpness-enhancement processing to said image-processing object pixel, by employing said specific spatial filter selected by said filter selecting section.

12. The apparatus of claim 11,
wherein said deriving section applies a multi-resolution conversion processing to said input image so as to decompose said input image into a plurality of decomposed images, and then, derives said image characteristic information from said plurality of decomposed images generated by applying said multi-resolution conversion processing.

13. The apparatus of claim 12,
wherein said deriving section employs a Dyadic Wavelet transform in an image-decomposing process at a level higher than at least level 2 of said multi-resolution conversion processing, and then, derives edge information, serving as said image characteristic information with respect to edge portions included in said input image, from said plurality of decomposed images generated by applying said Dyadic Wavelet transform.

14. The apparatus of claim 11,
wherein said deriving section derives information, representing a dispersion degree of signal values of plural pixels residing on positions being substantially equidistant from said image-processing object pixel in said predetermined area, as said image characteristic information.

15. A computer program for executing operations for processing an input image, so as to output a processed image revised from said input image, comprising the functional steps of:
deriving image characteristic information of a predetermined area, which includes adjacent pixels and is located in a vicinity of an image-processing object pixel other than said adjacent pixels, from information of said adjacent pixels residing in said predetermined area, both said adjacent pixels and said image-processing object pixel being included in said input image; and
applying a sharpness-enhancement processing to said image-processing object pixel, based on said image characteristic information derived in said deriving step.

16. The computer program of claim 15,
wherein said image characteristic information includes at least one of a sum of differential signal absolute-values between said adjacent pixels residing in said predetermined area, a variance of each signal value of said adjacent pixels residing in said predetermined area and a standard deviation of each signal value of said adjacent pixels residing in said predetermined area.

17. The computer program of claim 1, further comprising the functional step of:
selecting a specific spatial filter out of a plurality of spatial filters, which are different relative to each other in terms of relationships between image-edge directions and edge-enhancing degrees, based on said image characteristic information derived in said deriving step;
wherein said specific spatial filter, selected in said selecting step, is employed for said sharpness-enhancement processing.

18. A computer program for executing operations for processing an input image, so as to output a processed image revised from said input image, comprising the functional steps of:
deriving image characteristic information of a predetermined area, which includes adjacent pixels and is located in a vicinity of an image-processing object pixel other than said adjacent pixels, from information of said adjacent pixels residing in said predetermined area, both said adjacent pixels and said image-processing object pixel being included in said input image; and
selecting a specific spatial filter out of a plurality of spatial filters, which are different relative to each other in terms of relationships between image-edge directions and edge-enhancing degrees, based on said image characteristic information derived in said deriving step;
applying a sharpness-enhancement processing to said image-processing object pixel, by employing said specific spatial filter selected in said selecting step.

19. The computer program of claim 18,
wherein, in said deriving step, a multi-resolution conversion processing is applied to said input image so as to decompose said input image into a plurality of decomposed images, and then, said image characteristic information are derived from said plurality of decomposed images generated by said multi-resolution conversion processing.

20. The computer program of claim 19,
wherein, in said deriving step, a Dyadic Wavelet transform is employed in an image-decomposing process at a level higher than at least level 2 of said multi-resolution conversion processing, and then, edge information, serving as said image characteristic information with respect to edge portions included in said input image, are derived from said plurality of decomposed images generated by said Dyadic Wavelet transform.

21. The computer program of claim 18,
wherein, in said deriving step, information, representing a dispersion degree of signal values of plural pixels residing on positions being substantially equidistant from said image-processing object pixel in said predetermined area, are derived as said image characteristic information.
